(19) United States
(12) Patent Application Publication
(10) Pub. No.: US 2025/0167196 A1
(43) Pub. Date: May 22, 2025

(54) A Conductive Composition

(71) Applicant: GRST International Limited, Hong Kong (CN)

(72) Inventors: Kam Piu Ho, Hong Kong (CN); Yingkai Jiang, Shenzhen (CN); Priscilla Huen, Hong Kong (CN)

(21) Appl. No.: 18/721,886

(22) PCT Filed: Dec. 28, 2021
(86) PCT No.: PCT/CN2021/142150

§ 371 Date: Jun. 20, 2024

(51) Int. Cl. H01M 4/04; H01M 4/02; H01M 4/1391; H01M 4/525; H01M 4/62

(52) U.S. Cl. CPC H01M 4/0404; H01M 4/1391; H01M 4/525; H01M 4/622; H01M 4/625; H01M 2004/027; H01M 2004/028

(57) ABSTRACT

A conductive composition for a secondary battery, the conductive composition comprises a copolymer, carbon nanotubes (CNTs), and an aqueous solvent. The copolymer comprises a structural unit (a), a structural unit (b), and a structural unit (c), and has excellent adhesion to the surface of the CNTs as well as a high affinity for the aqueous solvent. As a result, the CNTs can be dispersed more uniformly in the aqueous solvent of the conductive composition, and the conductive composition can remain stable even after a significant period of time. Therefore, the CNTs can be more easily handled and adapted for use in various application. An electrode slurries comprising an electrode active material. Battery cells comprising an electrode prepared using such the electrode slurry exhibit impressive electrochemical performances.

### FIELD OF THE INVENTION

The present invention relates to the field of batteries. In particular, this invention relates to a conductive composition for lithium-ion batteries and other batteries, and a slurry comprising the same.

### BACKGROUND OF THE INVENTION

Over the past decades, lithium-ion batteries (LIBs) have become to be widely utilized in various applications, especially consumer electronics, because of their outstanding energy density, long cycle life and high discharging capability. Due to rapid market development of electric vehicles (EV) and grid energy storage, high-performance, low-cost LIBs are currently offering one of the most promising options for large-scale energy storage devices.

Generally, lithium-ion battery electrodes are manufactured by casting an organic-based slurry onto a metallic current collector. The slurry contains electrode active material, conductive carbon, and binder in an organic solvent. The binder, most commonly polyvinylidene fluoride (PVDF), is dissolved in the solvent and provides a good electrochemical stability and high adhesion to the electrode materials and current collectors. However, PVDF can only dissolve in some specific organic solvents such as N-methyl-2-pyrrolidone (NMP) which is flammable and toxic and hence requires specific handling.

An NMP recovery system must be in place during the drying process to recover NMP vapors. This will generate significant costs in the manufacturing process since it requires a large capital investment. The use of less expensive and more environmentally-friendly solvents, such as aqueous solvents, most commonly water, is preferred in the present invention since it can reduce the large capital cost of the recovery system. The attempts to replace the organic NMP-based coating process with a water-based coating process have been successful for the negative electrode. A typical water-based slurry for anode coating comprises carboxymethyl cellulose (CMC) and styrene-butadiene rubber (SBR). Within the battery, cathodes are at high voltage. Most rubbers including SBR are only stable at the low voltage of the anode and will decompose at high voltage. Therefore, contrary to anodes, water-based coating for cathodes is much of a challenge.

It is worth noting that the above problems are not particular to lithium-ion batteries. Other types of batteries, such as sodium-ion batteries, may also encounter similar problems.

Carbon-based materials such as amorphous carbon, graphene, carbon black, carbon nanotubes (CNTs), carbon nanofibers and fullerene have been widely used as conductive agents in the field due to their excellent electrical properties and thermal conductivity. Particularly, CNTs, tube-type carbon with very high aspect ratios, are expected to be the emerging conductive agent in various fields. CNTs consist of carbon network with honeycomb arrangements of the carbon atoms in the graphite sheets, with interlocking hexagons of six carbons forming a tubular structure. The exceptional mechanical and electrical properties of the CNTs stem from their quasi-one-dimensional structure and the graphite-like arrangement of the carbon atoms. In addition, their high thermal conductivity promotes heat dissipation during battery charge/discharge cycle, improving the performance of batteries at high and low temperatures, and thus extending the service life of batteries.

However, due to strong intermolecular interactions between CNTs, CNTs have a tendency to aggregate and are difficult to disperse in most solvents. As a result, there are considerable challenges in integrating CNTs into manufacturing processes that involve mixing CNTs in solvent, such as battery-related manufacturing processes. Despite the favorable properties of CNTs, the difficulty in processing and handling CNTs has hindered its widespread utilization in battery-related applications. Therefore, methods of promoting dispersion of CNTs in solvent are an important area of current research.

KR Patent Application Publication No. 20190088330 A discloses manufacturing methods for a carbon nanotube-electrode active material composite powder and an electrode comprising the same which aim to improve the electrical conductivity and battery performance. In attempt to achieve uniform carbon nanotube dispersion, carbon nanotube is dispersed in N-methyl-2-pyrrolidone (NMP) solvent and stirred through a stirrer to prevent agglomeration between carbon nanotubes. Polymeric binder, for example, polyvinylidene fluoride (PVDF) and the like may be further incorporated in the preparation of the electrode slurry. However, the application of this method is limited by its slather use of expensive and toxic organic solvent NMP. The use of aqueous solutions instead of organic solvents is preferred for significantly reducing the manufacturing cost and environmental impacts and therefore water-based processing has been adopted in the present invention. In addition, the above method does not teach how to stabilize carbon nanotubes in an aqueous system.

In view of the above, the present inventors have studied the subject intensively. It was found that a novel conductive composition comprising CNTs, a copolymer, and an aqueous solvent is stable and, through the action of the copolymer, the CNTs are well dispersed in the aqueous solvent of the conductive composition. As a result, enhanced electrical conductivity of the conductive composition can be achieved. Furthermore, it has been found that a battery comprising an electrode produced using the conductive composition disclosed herein has an improved performance.

### SUMMARY OF THE INVENTION

The aforementioned needs are met by various aspects and embodiments disclosed herein. In one aspect, provided herein is a conductive composition for a battery, comprising a copolymer, CNTs, and an aqueous solvent.

In another aspect, provided herein is an electrode slurry for a battery, comprising an electrode active material and the conductive composition. In some embodiments, the slurry further comprises a conductive agent.

### BRIEF DESCRIPTION OF THE DRAWINGS

FIG. 1 depicts a sample of the conductive composition of Example 1.

FIGS. 2a and 2b show images of a dried sample of the conductive composition of Example 1, at 10000× and 50000× magnification respectively.

### DETAILED DESCRIPTION OF THE INVENTION

The term “electrode” refers to a “cathode” or an “anode.”

The term “positive electrode” is used interchangeably with cathode. Likewise, the term “negative electrode” is used interchangeably with anode.

The term “polymeric material”, “binder”, “polymeric binder” or “binder material” refers to a chemical compound, mixture of compounds, or polymer that is used to hold an electrode material and/or a conductive agent in place and adhere them onto a metal part or a current collector to form an electrode. In some embodiments, the polymeric material forms a colloid, solution or dispersion in an aqueous solvent such as water.

The term “conductive agent” refers to a material that has good electrical conductivity. Therefore, the conductive agent is often mixed with an electrode active material at the time of forming an electrode to improve electrical conductivity of the electrode. In some embodiments, the conductive agent is chemically active. In certain embodiments, the conductive agent is chemically inactive.

The term “carbon nanotube” refers to a hollow cylindrical carbon structure consisting of a hexagonal lattice of carbon atoms with diameters typically measured in nanometers.

The term “polymer” refers to a compound prepared by polymerizing monomers, whether of the same or a different type. The generic term “polymer” embraces the terms “homopolymer” as well as “copolymer”.

The term “homopolymer” refers to a polymer prepared by the polymerization of the same type of monomer.

The term “copolymer” refers to a polymer prepared by the polymerization of two or more different types of monomers.

The term “weight-average molecular weight” Mw of a polymer is defined mathematically as:

$${M}_{w} = \frac{\sum {N}_{i} {M}_{i}^{2}}{\sum {N}_{i} {M}_{i}}$$

where Nᵢ is the number of polymer molecules with a particular molecular weight Mᵢ.

The term “aqueous solvent” refers to a solvent wherein the solvent is water, or wherein the solvent comprises water and one or more minor components, with water comprising a majority of the solvent by weight.

The term “unsaturated” refers to a moiety having one or more units of unsaturation.

The term “alkyl” refers to a univalent group having the general formula CₙH₂ₙ₊₁ that is derived from removing a hydrogen atom from a saturated, unbranched or branched aliphatic hydrocarbon, where n is an integer. Alkyl groups can be unsubstituted or substituted with one or more suitable substituents.

The term “alkenyl” refers to an unsaturated straight chain, branched chain, or cyclic hydrocarbon radical that contains one or more carbon-carbon double bonds. Similarly, the term “alkynyl” refers to a univalent group derived from the removal of a hydrogen atom from any carbon atom of an unsaturated aliphatic hydrocarbon with at least one carbon-carbon triple bond. Alkenyls and alkynyls may be substituted or unsubstituted. Non-limiting examples of alkynyl include ethynyl, 3-methylpent-1-yn-3-yl(HC≡C—C(CH₃)(C₂H₅)—) and butadiynyl. Furthermore, the term “enynyl” refers to a univalent group derived from the removal of a hydrogen atom from any carbon atom of an unsaturated aliphatic hydrocarbon with at least one carbon-carbon double bond and at least one carbon-carbon triple bond.

The term “alkoxy” refers to an alkyl group attached to a carbon chain through an oxygen atom. Some non-limiting examples of the alkoxy group include methoxy, ethoxy, propoxy, butoxy, and the like. Alkoxy groups may be substituted or unsubstituted.

The term “alkylene” refers to a saturated divalent hydrocarbon group derived from a straight or branched chain saturated hydrocarbon by the removal of two hydrogen atoms. The alkylene group is exemplified by methylene (—CH₂—), ethylene (—CH₂CH₂—), isopropylene (—CH(CH₃)CH₂—), and the like. The alkylene group is optionally substituted with one or more substituents described herein.

The term “aryl” refers to an organic radical derived from a monocyclic or polycyclic aromatic hydrocarbon by removing a hydrogen atom. Non-limiting examples of the aryl group include phenyl, naphthyl, benzyl, tolanyl, sexiphenyl, phenanthrenyl, anthracenyl, coronenyl, and tolanylphenyl. An aryl group can be unsubstituted or substituted with one or more suitable substituents.

The term “carbonyl” refers to —(C═O)—.

The term “acyl” refers to —(C═O)—Z, wherein Z is alkyl. The term “acyloxy” refers to —O—(C═O)—Z, wherein Z is also alkyl.

The term “amido” refers to —NH(C═O)—R.

The term “aliphatic” refers to an organic functional group, compound or class of compounds that do not comprise any aromatic rings. Non-limiting examples of aliphatic functional groups include alkyl, alkenyl, alkynyl, and alkylene.

The term “aromatic” refers to an organic functional group, compound or class of compounds comprising at least one aromatic rings, optionally including heteroatoms or substituents. Examples of aromatic functional groups include, but are not limited to, phenyl, tolyl, biphenyl, o-terphenyl, m-terphenyl, p-terphenyl, naphthyl, anthryl, phenanthryl, pyrenyl, triphenylenyl, and derivatives thereof.

The term “substituted” as used to describe a compound or chemical moiety refers to that at least one hydrogen atom of that compound or chemical moiety is replaced with a second chemical moiety. Examples of substituents include, but are not limited to, halogen; alkyl; heteroalkyl; alkenyl; alkynyl; enynyl; aryl; heteroaryl; hydroxyl; alkoxyl; amino; nitro; thiol; thioether; imine; cyano; amido; phosphonato; phosphine; carboxyl; thiocarbonyl; sulfonyl; sulfonamide; acyl; formyl; acyloxy; alkoxycarbonyl; oxo; haloalkyl (e.g., trifluoromethyl); carbocyclic cycloalkyl, which can be monocyclic or fused or non-fused polycyclic (e.g., cyclopropyl, cyclobutyl, cyclopentyl or cyclohexyl) or a heterocycloalkyl, which can be monocyclic or fused or non-fused polycyclic (e.g., pyrrolidinyl, piperidinyl, piperazinyl, morpholinyl or thiazinyl); carbocyclic or heterocyclic, monocyclic or fused or non-fused polycyclic aryl (e.g., phenyl, naphthyl, pyrrolyl, indolyl, furanyl, thiophenyl, imidazolyl, oxazolyl, isoxazolyl, thiazolyl, triazolyl, tetrazolyl, pyrazolyl, pyridinyl, quinolinyl, isoquinolinyl, acridinyl, pyrazinyl, pyridazinyl, pyrimidinyl, benzimidazolyl, benzothiophenyl or benzofuranyl); amino (primary, secondary or tertiary); o-lower alkyl; o-aryl, aryl; aryl-lower alkyl; —CO₂CH₃; —CONH₂; —OCH₂CONH₂; —NH₂; —SO₂NH₂; —OCHF₂; —CF₃; —OCF₃; —NH(alkyl); —N(alkyl)₂; —NH(aryl); —N(alkyl) (aryl); —N(aryl)₂; —CHO; CO(alkyl); —CO(aryl); —CO₂(alkyl); and —CO₂(aryl); and such moieties can also be optionally substituted by a fused-ring structure or bridge, for example —OCH₂O—. These substituents can optionally be further substituted with a substituent. All chemical groups disclosed herein can be substituted, unless it is specified otherwise.

The term “straight-chain” refers to an organic compound or moiety that does not comprise a side chain or a cyclic structure; i.e., the carbon atoms of the organic compound or moiety all form a single linear arrangement. A straight-chain compound or moiety can be substituted or unsubstituted, as well as saturated or unsaturated.

The term “halogen” or “halo” refers to F, Cl, Br or I.

The term “monomeric unit” refers to the constitutional unit contributed by a single monomer to the structure of a polymeric material.

The term “structural unit” refers to the total monomeric units contributed by the same monomer type in a polymeric material.

The term “carboxylate salt” refers to a functional group derived from a carboxylic acid, wherein the proton of the carboxylic acid is replaced with a cation. In some embodiments, the proton of the carboxylic acid is replaced with a metal cation. In some embodiments, the proton of the carboxylic acid is replaced with an ammonium ion.

The term “homogenizer” refers to an equipment that can be used to homogenize materials. The term “homogenization” refers to a process of distributing the materials uniformly throughout a fluid. Some non-limiting examples of the homogenizer include stirring mixers, planetary mixers, blenders and ultrasonicators.

The term “mill” refers to an equipment that reduces the particle size of materials, the equipment comprising a mixer that can be used to mix or stir different materials for producing a homogeneous mixture. The mixing may be effected through the use of various objects, including but not limited to the surfaces of the vessel, pressurized gas, and heavy spheres.

The term “applying” refers to an act of laying or spreading a substance on a surface.

The term “current collector” refers to any conductive substrate, which is in contact with an electrode layer and is capable of conducting an electrical current flowing to electrodes during discharging or charging a secondary battery. Some non-limiting examples of the current collector include a single conductive metal layer or substrate and a single conductive metal layer or substrate with an overlying conductive coating layer, such as a carbon black-based coating layer. The conductive metal layer or substrate may be in the form of a foil or a porous body having a three-dimensional network structure, and may be a polymeric or metallic material or a metalized polymer. In some embodiments, the three-dimensional porous current collector is covered with a conformal carbon layer.

The term “electrode layer” refers to a layer, which is in contact with a current collector, that comprises an electrochemically active material. In some embodiments, the electrode layer is made by applying a coating on to the current collector. In some embodiments, the electrode layer is located on one side or both sides of the current collector. In other embodiments, the three-dimensional porous current collector is coated conformally with an electrode layer.

The term “room temperature” refers to indoor temperatures from about 18° C. to about 30° C., e.g., 18, 19, 20, 21, 22, 23, 24, 25, 26, 27, 28, 29, or 30° C. In some embodiments, room temperature refers to a temperature of about 20° C. +/−1° C. or +/−2° C. or +/−3° C. In other embodiments, room temperature refers to a temperature of about 22° C. or about 25° C.

The term “solid content” refers to the amount of non-volatile material remaining after evaporation.

The term “peeling strength” refers to the amount of force required to separate a current collector and an electrode active material coating that are adhered to each other. It is a measure of the binding strength between such two materials and is usually expressed in N/cm.

The term “adhesive strength” refers to the amount of force required to separate a current collector and a polymeric material coating that are adhered to each other. It is a measure of the binding strength between such two materials and is usually expressed in N/cm.

The term “ampere-hour (Ah)” refers to a unit used in specifying the storage capacity of a battery. For example, a battery with 1 Ah capacity can supply a current of one ampere for one hour or 0.5 A for two hours, etc. Therefore, 1 Ampere-hour (Ah) is the equivalent of 3,600 coulombs of electrical charge. Similarly, the term “milliampere-hour (mAh)” also refers to a unit of the storage capacity of a battery and is 1/1,000 of an ampere-hour.

In the following description, all numbers disclosed herein are approximate values, regardless whether the word “about” or “approximate” is used in connection therewith. They may vary by 1 percent, 2 percent, 5 percent, or, sometimes, 10 to 20 percent. Whenever a numerical range with a lower limit, R^{L}, and an upper limit, R^{U}, is disclosed, any number falling within the range is specifically disclosed. In particular, the following numbers within the range are specifically disclosed: R=R^{L}+k*(R^{U}−R^{L}), wherein k is a variable ranging from 0 percent to 100 percent. Moreover, any numerical range defined by two R numbers as defined in the above is also specifically disclosed.

In the present description, all references to the singular include references to the plural and vice versa. In the present description, where the context allows, all references to an “aqueous solvent” may also specifically refer to water.

Conductive agents are commonly employed in cathode formulations to enhance the electrical conductivity of cathode. Carbon-based materials, particularly carbon nanotubes (CNTs), have seen use as conductive agents due to their attractive mechanical properties, namely tensile strength and elastic modulus, remarkable flexibility, excellent thermal and electrical conductivities, low percolation threshold (loading weight at which a sharp drop in resistivity occurs), and small size and high aspect ratios (length to diameter ratio). The addition of CNTs in an electrode observably improves the electrochemical performance of the electrode.

However, strong intermolecular interactions between CNTs lead to aggregation of CNTs into bundles or agglomerates, hence CNTs disperse poorly in most solvents. Accordingly, despite the favorable properties of CNTs, the difficulty of processing CNTs hinder the widespread usage of CNTs in battery-related applications. In particular, for greater safety and environmental compatibility, the development of methods to improve dispersion of CNTs in aqueous solvents such as water is of highest priority.

Accordingly, a novel conductive composition comprising CNTs, a copolymer, and an aqueous solvent is proposed. The copolymer has good adhesion to the surface of the CNTs and high affinity for the aqueous solvent. Therefore, the CNTs can be effectively dispersed in the aqueous solvent of the conductive composition, making them easier to process. The conductive composition can also maintain good CNT performance in various aspects, such as electrical conductivity. Such a conductive composition is therefore very suitable for use in electrode slurries of batteries.

In certain embodiments, the aqueous solvent is water. In some embodiments, the aqueous solvent is selected from the group consisting of tap water, bottled water, purified water, pure water, distilled water, de-ionized water (DI water), D20, and combinations thereof.

In some embodiments, the aqueous solvent consists solely of water, that is, the proportion of water in the aqueous solvent is 100% by weight, and no minor component is present in the aqueous solvent.

In some embodiments, the CNTs can be selected from the group consisting of multi-walled carbon nanotubes (MWCNTs), few-walled carbon nanotubes (FWCNTs), double-walled carbon nanotube (DWCNTs), single-walled carbon nanotubes (SWCNTs), and combinations thereof. It is not preferable for the CNTs used in the present invention to be in the form of a paste, slurry or composition comprising multiple components since these pastes, slurries or compositions would often also contain additives in order to disperse the CNTs. These additives could interfere with the ability of the copolymer in dispersing the CNTs within the aqueous solvent of the conductive composition or an electrode slurry produced therefrom. Furthermore, the organic solvent used as the dispersion medium of CNT could also affect the ability of the copolymer in dispersing the CNTs in the aqueous conductive composition or an electrode slurry produced therefrom. Accordingly, it is preferable for dry CNTs to be used in the present invention, for example in the form of powder.

CNTs have a diameter ranging from several nanometers to several tens of nm, and a length ranging from several μm to several hundreds of μm. As a result, they have a large aspect ratio (ratio of length to diameter). In some embodiments, the average diameter of the CNTs is from about 0.1 nm to about 100 nm, from about 0.1 nm to about 90 nm, from about 0.1 nm to about 80 nm, from about 0.1 nm to about 70 nm, from about 0.1 nm to about 60 nm, from about 0.1 nm to about 50 nm, from about 0.1 nm to about 40 nm, from about 0.1 nm to about 30 nm, from about 1 nm to about 100 nm, from about 1 nm to about 90 nm, from about 1 nm to about 80 nm, from about 1 nm to about 70 nm, from about 1 nm to about 60 nm, from about 1 nm to about 50 nm, from about 1 nm to about 40 nm, from about 1 nm to about 30 nm, from about 1 nm to about 25 nm, from about 1 nm to about 20 nm, from about 1 nm to about 15 nm, from about 3 nm to about 50 nm, from about 3 nm to about 40 nm, from about 3 nm to about 30 nm, from about 3 nm to about 25 nm, from about 3 nm to about 20 nm, from about 3 nm to about 15 nm, from about 5 nm to about 30 nm, from about 5 nm to about 25 nm, from about 5 nm to about 20 nm, from about 5 nm to about 15 nm, from about 5 nm to about 10 nm, from about 7 nm to about 25 nm, from about 7 nm to about 20 nm, from about 7 nm to about 15 nm, or from about 7 nm to about 10 nm.

In some embodiments, the average diameter of the CNTs is less than 100 nm, less than 90 nm, less than 80 nm, less than 70 nm, less than 60 nm, less than 50 nm, less than 40 nm, less than 30 nm, less than 25 nm, less than 20 nm, less than 15 nm, less than 13 nm, less than 11 nm, less than 9 nm, less than 7 nm, less than 5 nm, less than 3 nm, or less than 1 nm. In some embodiments, the average diameter of the CNTs is more than 0.1 nm, more than 1 nm, more than 3 nm, more than 5 nm, more than 7 nm, more than 9 nm, more than 11 nm, more than 13 nm, more than 15 nm, more than 20 nm, more than 25 nm, more than 30 nm, more than 40 nm, more than 50 nm, more than 60 nm, more than 70 nm, more than 80 nm, or more than 90 nm.

In some embodiments, the average length of the CNTs is from about 0.1 μm to about 500 μm, from about 0.1 μm to about 400 μm, from about 0.1 μm to about 300 μm, from about 0.1 μm to about 250 μm, from about 0.1 μm to about 200 μm, from about 0.1 μm to about 150 μm, from about 0.1 μm to about 100 μm, from about 1 μm to about 500 μm, from about 1 μm to about 400 μm, from about 1 μm to about 300 μm, from about 1 μm to about 250 μm, from about 1 μm to about 200 μm, from about 1 μm to about 150 μm, from about 1 μm to about 100 μm, from about 1 μm to about 80 μm, from about 1 μm to about 60 μm, from about 1 μm to about 50 μm, from about 5 μm to about 500 μm, from about 5 μm to about 300 μm, from about 5 μm to about 200 μm, from about 5 μm to about 100 μm, from about 5 μm to about 50 μm, from about 5 μm to about 40 μm, from about 5 μm to about 30 μm, from about 5 μm to about 20 μm, from about 20 μm to about 200 μm, from about 20 μm to about 100 μm, from about 20 μm to about 50 μm, from about 50 μm to about 250 μm, from about 50 μm to about 200 μm, from about 50 μm to about 150 μm, from about 50 μm to about 100 μm, or from about 50 μm to about 80 μm.

In certain embodiments, the average length of the CNTs is less than 500 μm, less than 400 μm, less than 300 μm, less than 250 μm, less than 200 μm, less than 150 μm, less than 100 μm, less than 80 μm, less than 60 μm, less than 50 μm, less than 40 μm, less than 30 μm, less than 20 μm, less than 15 μm, less than 10 μm, less than 5 μm, or less than 1 μm. In some embodiments, the average length of the CNTs is more than 0.1 μm, more than 1 μm, more than 5 μm, more than 10 μm, more than 15 μm, more than 20 μm, more than 30 μm, more than 40 μm, more than 50 μm, more than 60 μm, more than 80 μm, more than 100 μm, more than 150 μm, more than 200 μm, more than 250 μm, more than 300 μm, or more than 400 μm.

In some embodiments, the aspect ratio of the CNTs is from about 10 to about 5×10⁶, from about 50 to about 5×10⁶, from about 100 to about 5×10⁶, from about 200 to about 5×10⁶, from about 400 to about 5×10⁶, from about 600 to about 5×10⁶, from about 800 to about 5×10⁶, from about 1×10³ to about 5×10⁶, from about 5×10³ to about 5×10⁶, from about 1×10⁴ to about 5×10⁶, from about 5×10⁴ to about 5×10⁶, from about 1×10⁵ to about 5×10⁶, from about 10 to about 1×10⁶, from about 50 to about 1×10⁶, from about 100 to about 1×10⁶, from about 200 to about 1×10⁶, from about 400 to about 1×10⁶, from about 600 to about 1×10⁶, from about 800 to about 1×10⁶, from about 1×10³ to about 1×10⁶, from about 5×10³ to about 1×10⁶, from about 1×10⁴ to about 1×10⁶, from about 5×10⁴ to about 1×10⁶, from about 1×10⁵ to about 1×10⁶, from about 100 to about 3×10⁵, from about 200 to about 3×10⁵, from about 400 to about 3×10⁵, from about 600 to about 3×10⁵, from about 800 to about 3×10⁵, from about 1×10³ to about 3×10⁵, from about 5×10³ to about 3×10⁵, from about 1×10⁴ to about 3×10⁵, from about 100 to about 1×10⁵, from about 500 to about 1×10⁵, from about 1×10³ to about 1×10⁵, from about 5×10³ to about 1×10⁵, from about 1×10⁴ to about 1×10⁵, from about 2×10⁴ to about 1×10⁵, from about 4×10⁴ to about 1×10⁵, from about 500 to about 4×10⁴, from about 1×10³ to about 4×10⁴, from about 5×10³ to about 4×10⁴, from about 1×10⁴ to about 4×10⁴, from about 1×10³ to about 1×10⁴, from about 5×10³ to about 1×10⁴, from about 1×10³ to about 6×10³, from about 2×10³ to about 6×10³, or from about 4×10³ to about 6×10³.

In certain embodiments, the aspect ratio of the CNTs is less than 5×10⁶, less than 1×10⁶, less than 3×10⁵, less than 1×10⁵, less than 8×10⁴, less than 6×10⁴, less than 4×10⁴, less than 2×10⁴, less than 1×10⁴, less than 8×10³, less than 6×10³, less than 4×10³, less than 2×10³, less than 1×10³, less than 800, less than 600, less than 400, less than 200, less than 100, or less than 5×10. In some embodiments, the aspect ratio of the CNTs is more than 10, more than 50, more than 100, more than 200, more than 400, more than 600, more than 800, more than 1×10³, more than 2×10³, more than 4×10³, more than 6×10³, more than 8×10³, more than 1×10⁴, more than 2×10⁴, more than 4×10⁴, more than 6×10⁴, more than 8×10⁴, more than 1×10⁵, more than 3×10⁵, or more than 1×10⁶.

As a result of the small size of the CNTs, CNTs have a high specific surface area. In some embodiments, the BET specific surface area of the CNTs is from about 100 m²/g to about 1,500 m²/g, from about 100 m²/g to about 1,250 m²/g, from about 100 m²/g to about 1,000 m²/g, from about 100 m²/g to about 800 m²/g, from about 100 m²/g to about 700 m²/g, from about 100 m²/g to about 600 m²/g, from about 100 m²/g to about 500 m²/g, from about 100 m²/g to about 450 m²/g, from about 100 m²/g to about 400 m²/g, from about 100 m²/g to about 350 m²/g, from about 100 m²/g to about 300 m²/g, from about 100 m²/g to about 250 m²/g, from about 100 m²/g to about 225 m²/g, from about 100 m²/g to about 200 m²/g, from about 150 m²/g to about 1,000 m²/g, from about 150 m²/g to about 800 m²/g, from about 150 m²/g to about 700 m²/g, from about 150 m²/g to about 600 m²/g, from about 150 m²/g to about 500 m²/g, from about 150 m²/g to about 400 m²/g, from about 150 m²/g to about 300 m²/g, from about 200 m²/g to about 700 m²/g, from about 200 m²/g to about 600 m²/g, from about 200 m²/g to about 500 m²/g, from about 200 m²/g to about 400 m²/g, from about 200 m²/g to about 300 m²/g, from about 250 m²/g to about 500 m²/g, from about 250 m²/g to about 400 m²/g, or from about 250 m²/g to about 350 m²/g.

In certain embodiments, the BET specific surface area of the CNTs is less than 1,500 m²/g, less than 1,250 m²/g, less than 1,000 m²/g, less than 800 m²/g, less than 700 m²/g, less than 600 m²/g, less than 500 m²/g, less than 450 m²/g, less than 400 m²/g, less than 350 m²/g, less than 300 m²/g, less than 250 m²/g, less than 225 m²/g, less than 200 m²/g, less than 175 m²/g, less than 150 m²/g, less than 140 m²/g, less than 130 m²/g, less than 120 m²/g, or less than 110 m²/g. In some embodiments, the BET specific surface area of the CNTs is more than 100 m²/g, more than 110 m²/g, more than 120 m²/g, more than 130 m²/g, more than 140 m²/g, more than 150 m²/g, more than 175 m²/g, more than 200 m²/g, more than 225 m²/g, more than 250 m²/g, more than 300 m²/g, more than 350 m²/g, more than 400 m²/g, more than 450 m²/g, more than 500 m²/g, more than 600 m²/g, more than 700 m²/g, more than 800 m²/g, more than 1,000 m²/g, or more than 1,250 m²/g.

CNTs have excellent adhesion to said copolymer due to the formulation of the copolymer, while at the same time the copolymer is able to be readily solvated by the aqueous solvent. As a result, the copolymer is able to enhance dispersion of the CNTs in the aqueous solvent of the conductive composition and any electrode slurry produced therefrom. In certain embodiments, the copolymer comprises three structural units, (a), (b), and (c). Structural unit (a) comprises one or more cyano group-containing monomeric units, structural unit (b) comprises one or more carboxylate salt group-containing monomeric units, while structural unit (c) comprises one or more amide group-containing monomeric units. When the copolymer has structural units (a), (b), and (c) in the proportions as disclosed below, the copolymer would have excellent capability in improving CNT dispersion.

The cyano group(s) of structural unit (a) are able to strongly interact with the CNTs. This ensures that the CNTs can adhere to the copolymer, which, combined with the action of the other structural units of the copolymer, improves the dispersion of the CNTs in the aqueous solvent of the conductive composition.

In some embodiments, the one or more monomeric units of structural unit (a) is derived from a cyano group-containing monomer. Cyano group-containing monomers include α,β-ethylenically unsaturated nitrile monomers. In some embodiments, the cyano group-containing monomer is acrylonitrile, α-halogenoacrylonitrile, α-alkylacrylonitrile or a combination thereof. In some embodiments, the cyano group-containing monomer is α-chloroacrylonitrile, α-bromoacrylonitrile, α-fluoroacrylonitrile, methacrylonitrile, α-ethylacrylonitrile, α-isopropylacrylonitrile, α-n-hexylacrylonitrile, α-methoxyacrylonitrile, 3-methoxyacrylonitrile, 3-ethoxyacrylonitrile, α-acetoxyacrylonitrile, α-phenylacrylonitrile, α-tolylacrylonitrile, α-(methoxyphenyl) acrylonitrile, α-(chlorophenyl) acrylonitrile, α-(cyanophenyl) acrylonitrile, vinylidene cyanide, or a combination thereof.

The proportion of structural unit (a) within the copolymer is critical. When the proportion of structural unit (a) is too low, adhesion of the CNTs to the copolymer would be poor. Conversely, when the proportion of structural unit (a) is too high, there may be insufficient solvation. In either case, dispersion of the CNTs via the action of the copolymer would then be poor. In some embodiments, the proportion of structural unit (a) in the copolymer is from about 20% to about 70%, from about 20% to about 65%, from about 20% to about 60%, from about 20% to about 55%, from about 20% to about 50%, from about 20% to about 45%, from about 20% to about 40%, from about 30% to about 70%, from about 40% to about 70%, from about 40% to about 68%, from about 40% to about 65%, from about 40% to about 62%, from about 40% to about 60%, from about 40% to about 58%, from about 40% to about 55%, from about 40% to about 52%, from about 40% to about 50%, from about 40% to about 48%, from about 40% to about 45%, from about 45% to about 70%, from about 45% to about 68%, from about 45% to about 65%, from about 45% to about 62%, from about 45% to about 60%, from about 45% to about 58%, from about 45% to about 55%, from about 45% to about 52%, from about 45% to about 50%, from about 50% to about 70%, from about 50% to about 68%, from about 50% to about 65%, from about 50% to about 62%, from about 50% to about 60%, from about 50% to about 58%, from about 50% to about 55%, from about 55% to about 70%, from about 55% to about 68%, from about 55% to about 65%, from about 55% to about 62%, from about 55% to about 60%, from about 60% to about 70%, from about 60% to about 68%, from about 60% to about 65%, or from about 65% to about 70% by mole, based on the total number of moles of monomeric units present in the copolymer.

In some embodiments, the proportion of structural unit (a) in the copolymer is less than 70%, less than 68%, less than 65%, less than 62%, less than 60%, less than 58%, less than 55%, less than 52%, less than 50%, less than 48%, less than 45%, less than 42%, less than 40%, less than 38%, less than 35%, less than 32%, less than 30%, less than 28%, less than 25%, or less than 22% by mole, based on the total number of moles of monomeric units present in the copolymer. In some embodiments, the proportion of structural unit (a) in the copolymer is more than 20%, more than 22%, more than 25%, more than 28%, more than 30%, more than 32%, more than 35%, more than 38%, more than 40%, more than 42%, more than 45%, more than 48%, more than 50%, more than 52%, more than 55%, more than 58%, more than 60%, more than 62%, more than 65%, or more than 68% by mole, based on the total number of moles of monomeric units present in the copolymer.

A carboxylate salt group is the salt of a carboxylic acid group. In an aqueous solvent such as water, the carboxylate salt group would dissociate into an anionic carboxylate group and a cation. As a charged species, the carboxylate group readily attracts the polar molecules of the aqueous solvent to form solvation shells (hydration shells in the case of water). Therefore, the presence of the carboxylate salt group of structural unit (b) in the copolymer results in the solvation of the copolymer. The copolymer is thus able to increase the dispersion of the CNTs in the aqueous solvent of the conductive composition due to CNTs first adhering to the copolymer via structural unit (a) to form CNT-copolymer complexes, and then through the solvation of the CNT-copolymer complexes by the molecules of the aqueous solvent of the conductive composition.

It is not preferable for the one or more carboxylate salt-containing monomeric units in the copolymer in the present invention to instead be one or more carboxylic acid-containing monomeric units. Although both groups have very similar structures, it was found that a copolymer comprising carboxylic acid-containing monomeric units was less effective at improving CNT dispersion compared to an equivalent copolymer comprising carboxylic salt-containing monomeric units. A possible explanation for this is because although both carboxylic acid and carboxylate salt groups result in solvation, dissociation of carboxylate salt groups is complete while dissociation of carboxylic acid groups rarely so. Solvation via ionic interactions, which can only happen with dissociated species, is much stronger than polar and hydrogen bonding interactions, so solvation of carboxylic acid groups would then be weaker due to the presence of undissociated carboxylic acid. Accordingly, maximizing the presence of carboxylate salt-containing monomeric units instead of carboxylic acid-containing monomeric units in the copolymer is critical.

In some embodiments, the one or more monomeric units of structural unit (b) comprise an alkali metal cation. Examples of an alkali metal forming the alkali metal cation include lithium, sodium, and potassium. In some embodiments, the one or more monomeric units of structural unit (b) comprise an ammonium cation.

In some embodiments, the one or more monomeric units of structural unit (b) is derived from a carboxylate salt group-containing monomer. In some embodiments, the carboxylate salt group-containing monomer is acrylate salt, methacrylate salt, crotonate salt, 2-butyl crotonate salt, cinnamate salt, maleate salt, maleic anhydride salt, fumarate salt, itaconate salt, itaconic anhydride salt, tetraconate salt, or combinations thereof. In certain embodiments, the carboxylic salt group-containing monomer is 2-ethylacrylate salt, isocrotonate salt, cis-2-pentenoate salt, trans-2-pentenoate salt, angelate salt, tiglate salt, 3,3-dimethyl acrylate salt, 3-propyl acrylate salt, trans-2-methyl-3-ethyl acrylate salt, cis-2-methyl-3-ethyl acrylate salt, 3-isopropyl acrylate salt, trans-3-methyl-3-ethyl acrylate salt, cis-3-methyl-3-ethyl acrylate salt, 2-isopropyl acrylate salt, trimethyl acrylate salt, 2-methyl-3,3-diethyl acrylate salt, 3-butyl acrylate salt, 2-butyl acrylate salt, 2-pentyl acrylate salt, 2-methyl-2-hexenoate salt, trans-3-methyl-2-hexenoate salt, 3-methyl-3-propyl acrylate salt, 2-ethyl-3-propyl acrylate salt, 2,3-diethyl acrylate salt, 3,3-diethyl acrylate salt, 3-methyl-3-hexyl acrylate salt, 3-methyl-3-tert-butyl acrylate salt, 2-methyl-3-pentyl acrylate salt, 3-methyl-3-pentyl acrylate salt, 4-methyl-2-hexenoate salt, 4-ethyl-2-hexenoate salt, 3-methyl-2-ethyl-2-hexenoate salt, 3-tert-butyl acrylate salt, 2,3-dimethyl-3-ethyl acrylate salt, 3,3-dimethyl-2-ethyl acrylate salt, 3-methyl-3-isopropyl acrylate salt, 2-methyl-3-isopropyl acrylate salt, trans-2-octenoate salt, cis-2-octenoate salt, trans-2-decenoate salt, α-acetoxyacrylate salt, β-trans-aryloxyacrylate salt, α-chloro-β-E-methoxyacrylate salt, or combinations thereof. In some embodiments, the carboxylic salt group-containing monomer is methyl maleate salt, dimethyl maleate salt, phenyl maleate salt, bromo maleate salt, chloromaleate salt, dichloromaleate salt, fluoromaleate salt, difluoro maleate salt, or combinations thereof.

The proportion of structural unit (b) within the copolymer is critical. When the proportion of structural unit (b) is too low, the copolymer would be poorly solvated, and dispersion of CNTs via CNT-copolymer complexes would be poor. Conversely, when the proportion of structural unit (b) is too high, adhesion of the CNTs to the copolymer may be poor, and dispersion of the CNTs via CNT-copolymer complexes may also be poor since the copolymer would then adopt a rod-like conformation which would lead to poorer steric repulsion between CNT-copolymer complexes. Accordingly, dispersion of CNTs would then also be poor. In some embodiments, the proportion of structural unit (b) in the copolymer is from about 10% to about 50%, from about 15% to about 50%, from about 20% to about 50%, from about 25% to about 50%, from about 30% to about 50%, from about 32% to about 50%, from about 35% to about 50%, from about 38% to about 50%, from about 40% to about 50%, from about 20% to about 40%, from about 22% to about 40%, from about 25% to about 40%, from about 28% to about 40%, from about 30% to about 40%, from about 32% to about 40%, from about 35% to about 40%, from about 20% to about 35%, from about 22% to about 35%, from about 25% to about 35%, from about 28% to about 35%, from about 30% to about 35%, from about 20% to about 30%, from about 22% to about 30%, from about 20% to about 25%, or from about 22% to about 25% by mole, based on the total number of moles of monomeric units present in the copolymer.

In some embodiments, the proportion of structural unit (b) in the copolymer is less than 50%, less than 48%, less than 45%, less than 42%, less than 40%, less than 38%, less than 35%, less than 32%, less than 30%, less than 28%, less than 25%, less than 22%, less than 20%, less than 18%, less than 15%, or less than 12% by mole, based on the total number of moles of monomeric units present in the copolymer. In some embodiments, the proportion of structural unit (b) in the copolymer is more than 10%, more than 12%, more than 15%, more than 18%, more than 20%, more than 22%, more than 25%, more than 28%, more than 30%, more than 32%, more than 35%, more than 38%, more than 40%, more than 42%, more than 45%, or more than 48% by mole, based on the total number of moles of monomeric units present in the copolymer.

It was also discovered that the presence of structural units (a) and (b) alone resulted in a copolymer that was still not able to disperse CNTs in the aqueous solvent of the conductive composition, and aggregation of CNTs was still observed when a copolymer containing structural units (a) and (b) was used. Unexpectedly, when the copolymer structure comprises structural unit (c) comprising one or more amide group-containing monomeric units, this copolymer was very effective at dispersing the CNTs in the aqueous solvent of the conductive composition. A possible explanation for this is because the presence of structural unit (c) within the copolymer could result in the copolymer taking on a more globular conformation from a more rod-like conformation. As a result, steric repulsion between CNT-copolymer complexes is increased, and hence CNT dispersion is improved. In addition, amide groups are capable of conducting hydrogen bonding interactions with aqueous solvent molecules, meaning the one or more amide groups of structural unit (c) could also contribute to solvation of the copolymer and hence improve CNT dispersion. Therefore, the presence of structural unit (c) in the copolymer is critical.

In some embodiments, the one or more monomeric units of structural unit (c) is derived from an amide group-containing monomer. In some embodiments, the amide group-containing monomer is acrylamide, methacrylamide, N-methyl methacrylamide, N-ethyl methacrylamide, N-n-propyl methacrylamide, N-isopropyl methacrylamide, isopropyl acrylamide, N-n-butyl methacrylamide, N-isobutyl methacrylamide, N,N-dimethyl acrylamide, N,N-dimethyl methacrylamide, N,N-diethyl acrylamide, N,N-diethyl methacrylamide, N-methylol methacrylamide, N-(methoxymethyl) methacrylamide, N-(ethoxymethyl) methacrylamide, N-(propoxymethyl) methacrylamide, N-(butoxymethyl) methacrylamide, N,N-dimethylaminopropyl methacrylamide, N,N-dimethylaminoethyl methacrylamide, N,N-dimethylol methacrylamide, diacetone methacrylamide, diacetone acrylamide, methacryloyl morpholine, N-hydroxyl methacrylamide, N-methoxymethyl acrylamide, N-methoxymethyl methacrylamide, N,N′-methylene-bis-acrylamide (MBA), N-hydroxymethyl acrylamide, or a combination thereof.

The proportion of structural unit (c) within the copolymer is critical. When the proportion of structural unit (c) is too low, the ability of the copolymer in dispersing CNTs would be poor, as discussed above. Conversely, when the proportion of structural unit (c) is too high, this implies the proportion of structural unit (a) and/or (b) is/are relatively low, which would also result in weaker intermolecular interactions between the copolymer and the CNTs, and poorer solvation of the CNT-copolymer complexes. In some embodiments, the proportion of structural unit (c) in the copolymer is from about 6% to about 25%, from about 7% to about 25%, from about 8% to about 25%, from about 9% to about 25%, from about 10% to about 25%, from about 11% to about 25%, from about 12% to about 25%, from about 13% to about 25%, from about 14% to about 25%, from about 15% to about 25%, from about 16% to about 25%, from about 17% to about 25%, from about 18% to about 25%, from about 19% to about 25%, from about 20% to about 25%, from about 10% to about 22%, from about 10% to about 20%, from about 11% to about 20%, from about 12% to about 20%, from about 13% to about 20%, from about 14% to about 20%, from about 15% to about 20%, from about 10% to about 18%, from about 11% to about 18%, from about 12% to about 18%, from about 13% to about 18%, from about 10% to about 15%, or from about 11% to about 15% by mole, based on the total number of moles of monomeric units present in the copolymer.

In some embodiments, the proportion of structural unit (c) in the copolymer is less than 25%, less than 24%, less than 23%, less than 22%, less than 21%, less than 20%, less than 19%, less than 18%, less than 17%, less than 16%, less than 15%, less than 14%, less than 13%, less than 12%, less than 11%, less than 10%, less than 9%, less than 8%, or less than 7% by mole, based on the total number of moles of monomeric units present in the copolymer. In some embodiments, the proportion of structural unit (c) in the copolymer is more than 6%, more than 7%, more than 8%, more than 9%, more than 10%, more than 11%, more than 12%, more than 13%, more than 14%, more than 15%, more than 16%, more than 17%, more than 18%, more than 19%, more than 20%, more than 21%, more than 22%, more than 23%, or more than 24% by mole, based on the total number of moles of monomeric units present in the copolymer.

There are no particular limitations to the method of forming the copolymer, except that the performance of the copolymer should be sufficient in improving dispersion of the CNTs in the aqueous solvent of the conductive composition. In some embodiments, the copolymer is formed through the polymerization of monomers fulfilling the requirements of structural units (a), (b), and (c) respectively. In certain embodiments, one or more carboxylic group-containing monomers are first polymerized with monomers which structural unit (a) and structural unit (c) are derived from, then a base is added to neutralize the carboxylic acid groups to form the one or more carboxylic salt-containing monomeric units of structural unit (b). In such embodiments, it is preferable for an excess of base to be used in order to ensure all the carboxylic acid groups present are neutralized into carboxylic salt groups.

The weight-average molecular weight (Mw) of the copolymer is critical. When the weight-average molecular weight of the copolymer is too low, adhesion of the CNTs to the copolymer may be poor, and the ability of the copolymer to bring about dispersion of the CNTs may be poor. Conversely, when the weight-average molecular weight of the copolymer is too high, entanglement of copolymer strands may occur, which could lead to poor dispersion of CNTs. In some embodiments, the weight-average molecular weight of the copolymer is from about 50,000 g/mol to about 200,000 g/mol, from about 60,000 g/mol to about 200,000 g/mol, from about 70,000 g/mol to about 200,000 g/mol, from about 80,000 g/mol to about 200,000 g/mol, from about 90,000 g/mol to about 200,000 g/mol, from about 90,000 g/mol to about 190,000 g/mol, from about 90,000 g/mol to about 180,000 g/mol, from about 90,000 g/mol to about 170,000 g/mol, from about 90,000 g/mol to about 160,000 g/mol, from about 95,000 g/mol to about 160,000 g/mol, from about 100,000 g/mol to about 160,000 g/mol, from about 100,000 g/mol to about 150,000 g/mol, or from about 100,000 g/mol to about 140,000 g/mol.

In some embodiments, the weight-average molecular weight of the copolymer is less than 200,000 g/mol, less than 190,000 g/mol, less than 180,000 g/mol, less than 170,000 g/mol, less than 160,000 g/mol, less than 150,000 g/mol, less than 140,000 g/mol, less than 130,000 g/mol, less than 120,000 g/mol, less than 110,000 g/mol, less than 100,000 g/mol, less than 90,000 g/mol, less than 80,000 g/mol, less than 70,000 g/mol, or less than 60,000 g/mol. In some embodiments, the weight-average molecular weight of the copolymer is more than 50,000 g/mol, more than 60,000 g/mol, more than 70,000 g/mol, more than 80,000 g/mol, more than 90,000 g/mol, more than 100,000 g/mol, more than 110,000 g/mol, more than 120,000 g/mol, more than 130,000 g/mol, more than 140,000 g/mol, more than 150,000 g/mol, more than 160,000 g/mol, more than 170,000 g/mol, more than 180,000 g/mol, or more than 190,000 g/mol.

The proportion of CNTs in the conductive composition is critical. When such a proportion is too low, the effect of CNTs in improving battery performance may not be sufficient. Conversely, when such a proportion is too high, the amount of copolymer required to disperse the CNTs increases correspondingly, which may affect battery performance due to addition of excess amount of the binder. In some embodiments, the proportion of CNTs in the conductive composition is from about 0.2% to about 3.5%, from about 0.2% to about 3%, from about 0.2% to about 2.5%, from about 0.2% to about 2%, from about 0.2% to about 1.5%, from about 0.2% to about 1%, from about 0.2% to about 0.8%, from about 0.2% to about 0.5%, from about 0.3% to about 3.5%, from about 0.3% to about 3%, from about 0.3% to about 2%, from about 0.3% to about 1%, from about 0.4% to about 3.5%, from about 0.4% to about 3%, from about 0.4% to about 2%, from about 0.4% to about 1%, from about 0.5% to about 3.5%, from about 0.5% to about 3%, from about 0.5% to about 2%, from about 0.5% to about 1%, from about 0.6% to about 3.5%, from about 0.6% to about 3%, from about 0.6% to about 2%, from about 0.7% to about 3.5%, from about 0.7% to about 3%, from about 0.7% to about 2%, from about 0.8% to about 3.5%, from about 0.8% to about 3%, from about 0.8% to about 2%, from about 0.9% to about 3.5%, from about 0.9% to about 2%, from about 1% to about 3.5%, from about 1% to about 2%, from about 1% to about 1.5%, from about 1.5% to about 3.5%, from about 2% to about 3.5%, or from about 2.5% to about 3.5% by weight, based on the total weight of the conductive composition.

In some embodiments, the proportion of CNTs in the conductive composition is less than 3.5%, less than 3%, less than 2.5%, less than 2%, less than 1.75%, less than 1.5%, less than 1.3%, less than 1.1%, less than 1%, less than 0.9%, less than 0.8%, less than 0.7%, less than 0.6%, less than 0.5%, less than 0.4%, or less than 0.3% by weight, based on the total weight of the conductive composition. In some embodiments, the proportion of CNTs in the conductive composition is more than 0.2%, more than 0.3%, more than 0.4%, more than 0.5%, more than 0.6%, more than 0.7%, more than 0.8%, more than 0.9%, more than 1%, more than 1.1%, more than 1.3%, more than 1.5%, more than 1.75%, more than 2%, more than 2.5%, or more than 3% by weight, based on the total weight of the conductive composition.

The proportion of copolymer in the conductive composition is critical. When such a proportion is too low, the CNTs may be insufficiently dispersed in the aqueous solvent of the conductive composition. Conversely, when such a proportion is too high, the conductive composition may be overly viscous, and processibility of the conductive composition would be affected. In some embodiments, the proportion of the copolymer in the conductive composition is from about 4% to about 10%, from about 4.5% to about 10%, from about 5% to about 10%, from about 5.5% to about 10%, from about 6% to about 10%, from about 6.5% to about 10%, from about 7% to about 10%, from about 7.5% to about 10%, from about 8% to about 10%, from about 4% to about 8%, from about 4.5% to about 8%, from about 5% to about 8%, from about 5.5% to about 8%, from about 6% to about 8%, from about 4% to about 7%, from about 4.5% to about 7%, from about 5% to about 7%, from about 5.5% to about 7%, from about 6% to about 7%, from about 4% to about 6%, from about 4.5% to about 6%, from about 5% to about 6%, from about 5.5% to about 6%, or from about 4% to about 5% by weight, based on the total weight of the conductive composition.

In some embodiments, the proportion of the copolymer in the conductive composition is less than 10%, less than 9%, less than 8%, less than 7.5%, less than 7%, less than 6.8%, less than 6.5%, less than 6.2%, less than 6%, less than 5.8%, less than 5.5%, less than 5.2%, less than 5%, less than 4.8%, less than 4.5%, or less than 4.2% by weight, based on the total weight of the conductive composition. In some embodiments, the proportion of the copolymer in the conductive composition is more than 4%, more than 4.2%, more than 4.5%, more than 4.8%, more than 5%, more than 5.2%, more than 5.5%, more than 5.8%, more than 6%, more than 6.2%, more than 6.5%, more than 6.8%, more than 7%, more than 7.5%, more than 8%, or more than 9% by weight, based on the total weight of the conductive composition.

The ratio of the weight of the CNTs to the weight of the copolymer is particularly important. When the ratio of the weight of the CNTs to the weight of the copolymer is too low, this signifies that there is very little CNTs relative to copolymer, and the effect of CNTs in improving battery performance may not be significant, or the conductive composition may be overly viscous, and processibility of the conductive composition would be affected. Conversely, when the ratio of the weight of the CNTs to the weight of the copolymer is too high, this signifies that there is a lot of CNTs relative to copolymer, and the copolymer may not be sufficient to disperse the CNTs in the aqueous solvent of the conductive composition. In some embodiments, the ratio of the weight of the CNTs to the weight of the copolymer in the conductive composition is from about 1:20 to about 1:3, from about 1:20 to about 1:4, from about 1:20 to about 1:5, from about 1:20 to about 1:6, from about 1:20 to about 1:7, from about 1:20 to about 1:8, from about 1:20 to about 1:9, from about 1:20 to about 1:10, from about 1:20 to about 1:11, from about 1:20 to about 1:12, from about 1:20 to about 1:13, from about 1:20 to about 1:14, from about 1:20 to about 1:15, from about 1:15 to about 1:5, from about 1:15 to about 1:6, from about 1:15 to about 1:7, from about 1:15 to about 1:8, from about 1:15 to about 1:9, from about 1:15 to about 1:10, from about 1:12 to about 1:5, from about 1:12 to about 1:6, from about 1:12 to about 1:7, or from about 1:12 to about 1:8.

In some embodiments, the ratio of the weight of the CNTs to the weight of the copolymer in the conductive composition is more than 1:20, more than 1:19, more than 1:18, more than 1:17, more than 1:16, more than 1:15, more than 1:14, more than 1:13, more than 1:12, more than 1:11, more than 1:10, more than 1:9, more than 1:8, more than 1:7, more than 1:6, more than 1:5, or more than 1:4. In some embodiments, the ratio of the weight of the CNTs to the weight of the copolymer in the conductive composition is less than 1:3, less than 1:4, less than 1:5, less than 1:6, less than 1:7, less than 1:8, less than 1:9, less than 1:10, less than 1:11, less than 1:12, less than 1:13, less than 1:14, less than 1:15, less than 1:16, less than 1:17, less than 1:18, or less than 1:19.

The proportion of the sum of copolymer and CNTs in the conductive composition governs the solid content of the conductive composition. When such a proportion is too low, the processibility of the conductive composition would be poor since the solid content would be too low. Conversely, when such a proportion is too high, the processibility of the conductive composition would also be affected since the solid content would be too high. In some embodiments the proportion of the sum of copolymer and CNTs in the conductive composition is from about 4% to about 13%, from about 4.5% to about 13%, from about 5% to about 13%, from about 5.5% to about 13%, from about 6% to about 13%, from about 6.5% to about 13%, from about 7% to about 13%, from about 7.5% to about 13%, from about 8% to about 13%, from about 8.5% to about 13%, from about 9% to about 13%, from about 9.5% to about 13%, from about 10% to about 13%, from about 4% to about 10%, from about 4.5% to about 10%, from about 5% to about 10%, from about 5.5% to about 10%, from about 6% to about 10%, from about 6.5% to about 10%, from about 7% to about 10%, from about 4% to about 8%, from about 4.5% to about 8%, from about 5% to about 8%, from about 5.5% to about 8%, from about 6% to about 8%, from about 4% to about 7%, from about 4.5% to about 7%, from about 5% to about 7%, from about 5.5% to about 7%, from about 4% to about 6%, from about 4.5% to about 6%, from about 5% to about 6%, from about 4% to about 5.5%, or from about 4% to about 5% by weight, based on the total weight of the conductive composition.

In some embodiments the proportion of the sum of copolymer and CNTs in the conductive composition is less than 13%, less than 12%, less than 11%, less than 10%, less than 9.5%, less than 9%, less than 8.5%, less than 8%, less than 7.8%, less than 7.5%, less than 7.2%, less than 7%, less than 9.8%, less than 6.5%, less than 6.2%, less than 6%, less than 5.8%, less than 5.5%, less than 5.2%, less than 5%, less than 4.8%, less than 4.6%, or less than 4.4% by weight, based on the total weight of the conductive composition. In some embodiments, the proportion of the sum of copolymer and CNTs in the conductive composition is more than 4%, more than 4.2%, more than 4.4%, more than 4.6%, more than 4.8%, more than 5%, more than 5.2%, more than 5.5%, more than 5.8%, more than 6%, more than 6.2%, more than 6.5%, more than 6.8%, more than 7%, more than 7.2%, more than 7.5%, more than 7.8%, more than 8%, more than 8.5%, more than 9%, more than 9.5%, more than 10%, more than 11%, or more than 12% by weight, based on the total weight of the conductive composition.

The presence of surfactants, coupling agents, or inorganic nanoparticles is not preferable, since any of these additives could interfere with the ability of the copolymer to improve dispersion of the CNT of the conductive composition. Furthermore, when the conductive composition is put to use, the presence of such additives would affect the performance of the CNTs or even that of the application itself.

In some embodiments, no surfactant is present in the conductive composition. In some embodiments, the conductive composition is free of anionic surfactant, cationic surfactant, nonionic surfactant, and amphoteric surfactant.

In some embodiments, no anionic surfactants including alkyl sulfates, alkyl sulfonates, alkyl carboxylates, alkyl phosphates, alkyl phosphonates, alkyl aromatic sulfates, alkyl aromatic sulfonates, alkyl aromatic carboxylates, alkyl aromatic phosphates, alkyl aromatic phosphonates, alkyl alkoxy sulfates, alkyl alkoxy sulfonates, alkyl alkoxy carboxylates, alkyl alkoxy phosphates, alkyl alkoxy phosphonates, alkyl ester sulfates, alkyl ester sulfonates, alkyl ester carboxylates, alkyl ester phosphates, alkyl ester phosphonates, alkyl ether sulfates, alkyl ether sulfonates, alkyl ether carboxylates, alkyl ether phosphates, alkyl ether phosphonates, or combinations thereof, wherein the corresponding counterions for each anionic surfactant are independently selected from the group consisting of alkali metal ions, alkaline earth metal ions, ammonium ions, mono-/di- or tri-alkyl ammonium ions, mono-/di- or tri-(hydroxyalkyl) ammonium ions, and combinations thereof are present in the conductive composition.

In some embodiments, no anionic surfactants including fatty acid salts; polyoxyalkylene alkyl ether acetates; polyoxyalkylene alkyl ether sulfates; higher fatty acid amide sulfonates; N-acylsarcosin salts; polyoxyalkylene alkyl ether phosphate salts; long-chain sulfosuccinates; long-chain N-acylglutamates; polymers and copolymers comprising acrylic acids, anhydrides, esters, vinyl monomers and/or olefins and their alkali metal, alkaline earth metal and/or ammonium salt derivatives; salts of polycarboxylic acids; formalin condensate of naphthalene sulfonic acid; alkyl naphthalene sulfonic acid; naphthalene sulfonic acid; alkyl naphthalene sulfonate; formalin condensates of acids and naphthalene sulfonates such as their alkali metal salts, alkaline earth metal salts, ammonium salts or amine salts; melamine sulfonic acid; alkyl melamine sulfonic acid; formalin condensate of melamine sulfonic acid; formalin condensate of alkyl melamine sulfonic acid; alkali metal salts, alkaline earth metal salts, ammonium salts and amine salts of melamine sulfonates; lignin sulfonic acid; and alkali metal salts, alkaline earth metal salts, ammonium salts and amine salts of lignin sulfonates; metal dodecyl sulfate; metal dodecyl sulfonate; metal dodecyl carboxylate; metal dodecyl phosphate; metal dodecyl phosphonate; metal dodecyl ether sulfate; metal dodecyl ether sulfonate; metal dodecyl ether carboxylate; metal dodecyl ether phosphate; metal dodecyl ether phosphonate; metal dodecyl benzene sulfate; metal dodecyl benzene sulfonate; metal dodecyl benzene carboxylate; metal dodecyl benzene phosphate; metal dodecyl benzene phosphonate; metal stearate; olefin sulfonate; alpha olefin sulfonate, or combinations thereof are present in the conductive composition.

In some embodiments, no anionic surfactants including sodium dodecyl sulphate (SDS), lithium dodecyl sulphate (LDS), sodium lauryl ether sulfate (SLES), lithium dodecyl benzene sulfonate, sodium dodecyl benzene sulfonate (SDBS), paraffin sulfonate, ammonium or other alkali or alkaline-earth metal sarcosinate, ammonium or other alkali or alkaline-earth metal sulfosuccinate, ammonium or other alkali or alkaline-earth metal isethionate, ammonium or other alkali or alkaline-earth metal taurate, ammonium lauryl sulfate, ammonium laureth sulfate, triethylamine lauryl sulfate, triethylamine laureth sulfate, triethanolamine lauryl sulfate, triethanolamine laureth sulfate, monoethanolamine lauryl sulfate, monoethanolamine laureth sulfate, diethanolamine lauryl sulfate, diethanolamine laureth sulfate, lauric acid monoglyceride sodium sulfate, sodium lauryl sulfate, sodium laureth sulfate, potassium lauryl sulfate, potassium laureth sulfate, sodium lauryl phosphate, sodium tridecyl phosphate, sodium behenyl phosphate, sodium laureth-2 phosphate, sodium dilauryl phosphate, sodium ditridecyl phosphate, sodium lauroyl sarcosinate, lauroyl sarcosine, cocoyl sarcosine, ammonium cosyl sulfate, sodium cosyl sulfate, sodium trideceth sulfate, sodium tridecyl sulfate, ammonium trideceth sulfate, ammonium tridecyl sulfate, sodium cocoyl isethionate, disodium laureth sulfosuccinate, sodium methyl oleoyl taurate, sodium laureth carboxylate, sodium trideceth carboxylate, potassium cosyl sulfate, monoethanolamine cosyl sulfate, sodium tridecylbenzenesulfonate, ether sulfonate, lithium stearate, sodium stearate, or combinations thereof are present in the conductive composition.

In some embodiments, no cationic surfactants including alkyltrimethylammonium salts such as stearyltrimethylammonium chloride, lauryltrimethylammonium chloride and cetyltrimethylammonium bromide; dialkyldimethylammonium salts; trialkylmethylammonium salts; tetraalkylammonium salts; alkylamine salts; benzalkonium salts; alkylpyridinium salts; and imidazolium salts are present in the conductive composition.

In some embodiments, no nonionic surfactants including polyoxyalkylene oxide-added alkyl ethers; polyoxyalkylene styrene phenyl ethers; polyhydric alcohols; ester compounds of monovalent fatty acid; polyoxyalkylene alkylphenyl ethers; polyoxyalkylene fatty acid ethers; polyoxyalkylene sorbitan fatty acid esters; glycerin fatty acid esters; polyoxyalkylene castor oil; polyoxyalkylene hydrogenated castor oil; polyoxyalkylene sorbitol fatty acid ester; polyglycerin fatty acid ester; alkyl glycerin ether; polyoxyalkylene cholesteryl ether; alkyl polyglucoside; sucrose fatty acid ester; polyoxyalkylene alkyl amine; polyoxyethylene-polyoxypropylene block polymers; sorbitan fatty acid ester; and fatty acid alkanolamides are present in the conductive composition.

In some embodiments, no amphoteric surfactants including 2-undecyl-N, N-(hydroxyethylcarboxymethyl)-2-imidazoline sodium salt, 2-cocoyl-2-imidazolinium hydroxide-1-carboxyethyloxy disodium salt; imidazoline-based amphoteric surfactants; 2-heptadecyl-N-carboxymethyl-N-hydroxyethyl imidazolium betaine, lauryldimethylaminoacetic acid betaine, alkyl betaine, amide betaine, sulfobetaine and other betaine-based amphoteric surfactants; N-laurylglycine, N-lauryl β-alanine, N-stearyl β-alanine, lauryl dimethylamino oxide, oleyl dimethylamino oxide, sodium lauroyl glutamate, lauryl dimethylaminoacetic acid betaine, stearyl dimethylaminoacetic acid betaine, cocamidopropyl hydroxysultaine, and 2-alkyl-N-carboxymethyl-N-hydroxyethylimidazolinium betaine are present in the conductive composition.

In some embodiments, no coupling agents are present in the conductive composition. In certain embodiments, no silane coupling agents or titanate coupling agents are present in the conductive composition.

In some embodiments, no inorganic nanoparticles are present in the conductive composition. In some embodiments, no inorganic nanoparticles comprising Cs, Mg, Ca, Sr, Sc, Ti, Zr, Nb, Ta, Cr, Mo, W, Mn, Fe, Ru, Co, Ir, Nᵢ, Pd, Pt, Cu, Ag, Au, Zn, Cd, Al, Ga, In, Si, Ge, Sn, Pb, Sb, Te, compounds thereof, or combinations thereof are present in the conductive composition.

There are no particular limitations to the method of forming the conductive composition from the copolymer, CNTs, and aqueous solvent, except that all the materials should be present in the conductive composition, and that the CNTs and the copolymer are well dispersed in the aqueous solvent such that a homogeneous mixture is formed, for example through the use of a homogenizer. However, in order to ensure that the copolymer can effectively adhere to the surface of the CNTs effectively improve the dispersion of the CNTs in the aqueous solvent, it is preferable for the copolymer to be dispersed in the aqueous solvent first before the CNTs are added to form the conductive composition. There is no particular limitation on the homogenizer used, except that the homogenizer should be able to disperse the copolymer and the CNTs in the aqueous solvent well to form a homogenized conductive composition without damaging the structure of the CNTs. However, ultrasonicators are not preferred since it was found that ultrasonic waves could destroy the structure of CNTs. Instead, it is preferable for the homogenizer to be able to exert shear forces on the conductive composition during homogenization, since this would ensure homogeneous mixing, while at the same time minimizing structural damage of CNTs. Some non-limiting examples of suitable homogenizers include stirring mixers, planetary stirring mixers, blenders and mills. There is no particular limitation to the stirring speed, stirring time, or temperature of homogenization, except that such conditions should be sufficient for the resultant conductive composition to be homogeneous, wherein the CNTs and the copolymer are well-dispersed within the aqueous solvent of the conductive composition.

In some embodiments, the copolymer is in the form of a copolymer composition comprising the copolymer itself and a solvent. The composition of said solvent may be the solvent remaining from the polymerization process. In other embodiments, dry copolymer is used to form the copolymer composition.

The pH of the conductive composition is critical. When the pH of the conductive composition is too low, the carboxylate anions in the copolymer of the conductive composition would accept protons to form the corresponding carboxylic acid groups. As a result, solvation of the copolymer in the aqueous solvent of the conductive composition would be weaker and dispersion of the CNTs due to the action of the copolymer would then be poorer. Moreover, hydrogen bonding interactions between carboxylic acid groups in the copolymer could conversely lead to aggregation of the copolymer and hence the CNTs. Conversely, when the pH of the conductive composition is too high, hydrolysis of the cyano groups in the copolymer of the conductive composition could occur. As a result, there would be fewer cyano groups present in the copolymer, and intermolecular interactions between the copolymer and the CNTs would be weakened. Adhesion between the copolymer and CNTs would hence also be weaker. The dispersion of CNTs through the action of the copolymer would therefore be less effective. Accordingly, it is preferable for the pH of the conductive composition is moderately basic in nature.

In some embodiments, the pH of the conductive composition is from about 7 to about 12, from about 8 to about 12, from about 9 to about 12, from about 10 to about 12, about 7 to about 11.5, about 7 to about 11, about 7 to about 10.5, from about 7 to about 10, from about 7.5 to about 10, from about 8 to about 10, from about 8.5 to about 10, from about 9 to about 10, from about 7 to about 9, from about 7.5 to about 9, from about 8 to about 9, from about 7 to about 8.5, from about 7.5 to about 8.5, from about 8 to about 8.5, from about 7 to about 8, from about 7.5 to about 8, or from about 7 to about 7.5.

In some embodiments, the pH of the conductive composition is lower than 12, lower than 11.5, lower than 11, lower than 10.5, lower than 10, lower than 9.5, lower than 9, lower than 8.5, lower than 8, or lower than 7.5. In some embodiments, the pH of the conductive composition is higher than 7, higher than 7.5, higher than 8, higher than 8.5, higher than 9, higher than 9.5, higher than 10, higher than 10.5, higher than 11, or higher than 11.5.

The viscosity of the conductive composition is critical to the ease of processing of the conductive composition. When the viscosity of the conductive composition is too high, it may be challenging to maintain homogeneity of the conductive composition or handle the conductive composition when putting it to use. Conversely, when the viscosity of the conductive composition is too low, the subsequent processibility of the conductive composition would be poor. For example, when a conductive composition with a viscosity that is too low is used in an electrode slurry, the electrode slurry would have poor stability, poor viscosity characteristics, and considerable efforts would be required to adjust and manipulate physical properties of said slurry in order for the slurry to be able to successfully produce electrodes.

In some embodiments, the dynamic viscosity of the conductive composition at 20° C. is from about 500 mPa·s to about 2,000 mPa·s, from about 600 mPa·s to about 2,000 mPa·s, from about 700 mPa·s to about 2,000 mPa·s, from about 800 mPa·s to about 2,000 mPa·s, from about 900 mPa·s to about 2,000 mPa·s, from about 1,000 mPa·s to about 2,000 mPa·s, from about 1,100 mPa·s to about 2,000 mPa·s, from about 1,200 mPa·s to about 2,000 mPa·s, from about 1,300 mPa·s to about 2,000 mPa·s, from about 1,400 mPa·s to about 2,000 mPa·s, from about 1,500 mPa·s to about 2,000 mPa·s, from about 500 mPa·s to about 1,500 mPa·s, from about 600 mPa·s to about 1,500 mPa·s, from about 700 mPa·s to about 1,500 mPa·s, from about 800 mPa·s to about 1,500 mPa·s, from about 900 mPa·s to about 1,500 mPa·s, from about 1,000 mPa·s to about 1,500 mPa·s, from about 500 mPa·s to about 1,000 mPa·s, from about 600 mPa·s to about 1,000 mPa·s, from about 700 mPa·s to about 1000 mPa·s, or from about 500 mPa·s to about 800 mPa·s.

In some embodiments, the dynamic viscosity of the conductive composition at 20° C. is less than 2,000 mPa·s, less than 1,900 mPa·s, less than 1800 mPa·s, less than 1,700 mPa·s, less than 1,600 mPa·s, less than 1,500 mPa·s, less than 1,400 mPa·s, less than 1,300 mPa·s, less than 1,200 mPa·s, less than 1,100 mPa·s, less than 1,000 mPa·s, less than 900 mPa·s, less than 800 mPa·s, less than 700 mPa·s, or less than 600 mPa·s. In some embodiments, the dynamic viscosity of the conductive composition at 20° C. is more than 500 mPa·s, more than 600 mPa·s, more than 700 mPa·s, more than 800 mPa·s, more than 900 mPa·s, more than 1,000 mPa·s, more than 1,100 mPa·s, more than 1,200 mPa·s, more than 1,300 mPa·s, more than 1,400 mPa·s, more than 1,500 mPa·s, more than 1,600 mPa·s, more than 1,700 mPa·s, more than 1,800 mPa·s, or more than 1,900 mPa·s.

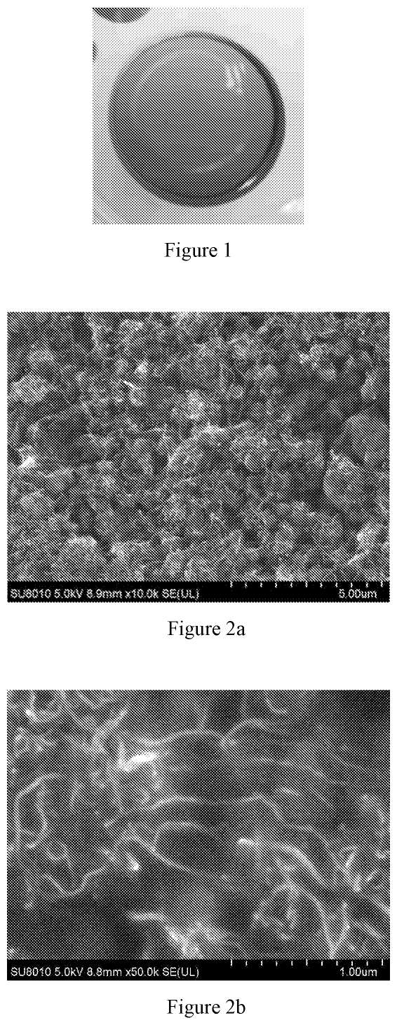

FIG. 1 depicts a sample of the conductive composition of Example 1, comprising a copolymer, CNTs, and water as the aqueous solvent. As shown, the conductive composition is homogeneous without any sedimentation or presence of aggregates. This shows that the CNTs are well dispersed in the aqueous solvent of the conductive composition.

FIGS. 2a and 2b show images of a dried sample of the conductive composition of Example 1 at 10,000× and 50,000× magnification respectively. The copolymer can be seen as larger structures in the background, while CNTs can be seen as thin white filaments. From the images, it can be seen that the CNTs are adhered to the copolymer strands. This shows that the CNTs are well dispersed in the aqueous solvent of the conductive composition through the action of the CNTs adhering to the copolymer and subsequent solvation of the CNT-copolymer complexes. In addition, the conductive composition was found to remain stable even after a significant period of time, and the conductive composition was found to have excellent CNT performance. Therefore, the conductive composition of the present invention has made CNTs easier to process and handle without compromising its desirable characteristics.

The conductive composition of the present invention is highly suitable for use in an electrode slurry for a battery. In some embodiments, the battery may be a primary battery or a secondary battery. Some non-limiting examples of battery types include alkaline batteries, aluminum-air batteries, lithium batteries, lithium air batteries, magnesium batteries, silver-oxide batteries, zinc-air batteries, aluminum-ion batteries, lead-acid batteries, lithium-ion batteries, magnesium-ion batteries, potassium-ion batteries, sodium-ion batteries, sodium-air batteries, silicon-air batteries, zinc-ion batteries, and sodium-sulfur batteries. Furthermore, depending on the state of the electrolyte being used (i.e., liquid or solid state), batteries can be classified as conventional batteries (when liquid electrolyte is used) or solid-state batteries (when solid electrolyte is used).

In some embodiments, the electrode slurry comprises an electrode active material and the conductive composition of the present invention. In some embodiments, additional aqueous solvent is further added to the aqueous solvent of the conductive composition in the formation of the electrode slurry. In certain embodiments, the electrode slurry additionally comprises a binding agent. In some embodiments, the electrode slurry additionally comprises a conductive agent. The electrode active material can be a cathode active material or an anode active material. When the electrode slurry comprises a cathode active material, the electrode slurry is a cathode slurry. When the electrode slurry comprises an anode active material, the electrode slurry is an anode slurry.

In some embodiments, the electrode active material is a cathode active material. In some embodiments, the cathode active material is selected from the group consisting of LiCoO₂, LiNiO₂, LiNi₁₋ₓMₓO₂, LiNiₓMn_{y}O₂, LiCoₓNi_{y}O₂, Li_{1+z}NiₓMn_{y}Co_{1-x-y}O₂, LiNiₓCo_{y}Al₂O₂, LiV₂O₅, LiTiS₂, LiMOS₂, LiMnO₂, LiCrO₂, LiMn₂O₄, Li₂MnO₃, LiFeO₂, LiFePO₄, and combinations thereof, wherein each x is independently from 0.1 to 0.9; each y is independently from 0 to 0.9; each z is independently from 0 to 0.4; and M is selected from the group consisting of Co, Mn, Al, Fe, Ti, Ga, Mg, and combinations thereof. In certain embodiments, each x in the above general formula is independently selected from 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875 and 0.9; each y in the above general formula is independently selected from 0, 0.025, 0.05, 0.075, 0.1, 0.125, 0.15, 0.175, 0.2, 0.225, 0.25, 0.275, 0.3, 0.325, 0.35, 0.375, 0.4, 0.425, 0.45, 0.475, 0.5, 0.525, 0.55, 0.575, 0.6, 0.625, 0.65, 0.675, 0.7, 0.725, 0.75, 0.775, 0.8, 0.825, 0.85, 0.875 and 0.9; each z in the above general formula is independently selected from 0, 0.025, 0.05, 0.075, 0.1, 0.125, 0.15, 0.175, 0.2, 0.225, 0.25, 0.275, 0.3, 0.325, 0.35, 0.375 and 0.4. In some embodiments, each x, y and z in the above general formula independently has a 0.01 interval.

In certain embodiments, the cathode active material is selected from the group consisting of LiNiₓMn_{y}O₂, Li_{1+z}NiₓMn_{y}CO_{1-x-y}O₂(NMC), LiNiₓCo_{y}Al₂O₂ (NCA), LiCoₓNi_{y}O₂ and combinations thereof, wherein each x is independently from 0.4 to 0.6; each y is independently from 0.2 to 0.4; and each z is independently from 0 to 0.1. In other embodiments, the cathode active material is not LiCoO₂, LiNiO₂, LiV₂O₅, LiTiS₂, LiMOS₂, LiMnO₂, LiCrO₂, LiMn₂O₄, LiFeO₂ or LiFePO₄. In further embodiments, the cathode active material is not LiNiₓMn_{y}O₂, Li_{1+z}NiₓMn_{y}CO_{1-x-y}O₂, LiNiₓCo_{y}Al₂O₂ or LiCoₓNi_{y}O₂, wherein each x is independently from 0.1 to 0.9; each y is independently from 0 to 0.45; and each z is independently from 0 to 0.2. In certain embodiments, the cathode active material is Li₁₊ₓNiₐMn_{b}Co_{c}Al_{(1-a-b-c)}O₂; wherein −0.25x≤0.2, 0≤a<1,0gb<1, 0≤c<1, and a+b+c≤1. In some embodiments, the cathode active material has the general formula Li₁₊ₓNiₐMn_{b}Co_{c}Al_{(1-a-b-c)}O₂, with 0.33<a≤0.92, 0.33≤a≤0.9, 0.33≤a≤0.8, 0.4≤a≤0.92, 0.4≤a≤0.9, 0.4≤a≤0.8, 0.5≤a≤0.92, 0.5≤a≤0.9,0.5≤a≤0.8, 0.6≤a≤0.92, or 0.6≤a≤0.9; 0<b≤0.5, 0≤b≤0.4, 0≤b≤0.3, 0≤b≤0.2, 0.1<b≤0.5, 0.1<b≤0.4, 0.1<b>0.3, 0.1<b>0.2, 0.2<b≤0.5, 0.2<b≤0.4, or 0.2<b≤0.3; 0≤c≤0.5, 0≤c<0.4, 0≤c<0.3, 0.1≤c<0.5, 0.1<c<0.4, 0.1<c<0.3, 0.1≤c<0.2, 0.2≤c≤0.5, 0.2≤c≤0.4, or 0.2≤c≤0.3. In some embodiments, the cathode active material has the general formula LiMPO₄, wherein M is selected from the group consisting of Fe, Co, Nᵢ, Mn, Al, Mg, Zn, Ti, La, Ce, Sn, Zr, Ru, Si, Ge, or combinations thereof.

In some embodiments, the cathode active material is selected from the group consisting of LifePO₄, LiCoPO₄, LiNiPO₄, LiMnPO₄, LiMnFePO₄, LiMnₓFe₍₁₋ₓ₎PO₄, and combinations thereof; wherein 0<x<1. In some embodiments, the cathode active material is LiNiₓMn_{y}O₄; wherein 0.1<x<0.9 and 0≤y≤2. In certain embodiments, the cathode active material is xLi₂MnO₃·(1−x) LiMO₂, wherein M is selected from the group consisting of Nᵢ, Co, Mn, and combinations thereof; and wherein 0<x<1. In some embodiments, the cathode active material is Li₃V₂(PO₄)₃, or LiVPO₄F. In certain embodiments, the cathode active material has the general formula Li₂MSiO₄, wherein M is selected from the group consisting of Fe, Co, Mn, Nᵢ, and combinations thereof.

In certain embodiments, the cathode active material is doped with a dopant selected from the group consisting of Co, Cr, V, Mo, Nb, Pd, F, Na, Fe, Ni, Mn, Al, Mg, Zn, Ti, La, Ce, Sn, Zr, Ru, Si, Ge, and combinations thereof. In some embodiments, the cathode active material is not doped with Co, Cr, V, Mo, Nb, Pd, F, Na, Fe, Ni, Mn, Mg, Zn, Ti, La, Ce, Ru, Si, or Ge. In certain embodiments, the cathode active material is not doped with Al, Sn or Zr.

In some embodiments, the cathode active material is LiNi_{0.33}Mn_{0.33}CO_{0.33}O₂ (NMC333), LiNi_{0.4}Mn_{0.4}CO_{0.2}O₂, LiNi_{0.5}Mn_{0.3}CO_{0.2}O₂ (NMC532), LiNi_{0.6}Mn_{0.2}CO_{0.2}O₂ (NMC622), LiNi_{0.7}Mn_{0.15}CO_{0.15}O₂, LiNi_{0.7}Mn_{0.1}CO_{0.2}O₂, LiNi_{0.8}Mn_{0.1}CO_{0.1}O₂ (NMC811), LiNi_{0.92}Mn_{0.04}CO_{0.04}O₂, LiNi_{0.85}Mn_{0.075}CO_{0.075}O₂, LiNi_{0.8}CO_{0.15}Al_{0.05}O₂, LiNi_{0.88}CO_{0.1}Al_{0.02}O₂, LiNiO₂ (LNO) or combinations thereof.

In other embodiments, the cathode active material is not LiCoO₂, LiNiO₂, LiMnO₂, LiMn₂O₄ or Li₂MnO₃. In further embodiments, the cathode active material is not LiNi_{0.33}Mn_{0.33}CO_{0.33}O₂, LiNi_{0.4}Mn_{0.4}CO_{0.2}O₂, LiNi_{0.5}Mn_{0.3}CO_{0.2}O₂, LiNi_{0.6}Mn_{0.2}CO_{0.2}O₂, LiNi_{0.7}Mn_{0.15}CO_{0.15}O₂, LiNi_{0.7}Mn_{0.1}CO_{0.2}O₂, LiNi_{0.8}Mn_{0.1}CO_{0.1}O₂, LiNi_{0.92}Mn_{0.04}CO_{0.04}O₂, LiNi_{0.85}Mn_{0.075}CO_{0.075}O₂, LiNi_{0.8}CO_{0.15}Al_{0.05}O₂, or LiNi_{0.88}CO_{0.1}Al_{0.02}O₂.

In certain embodiments, the cathode active material comprises or is a core-shell composite having a core and shell structure, wherein the core comprises a lithium transition metal oxide selected from the group consisting of Li₁₊ₓNiₐMn_{b}CoAl_{(1-a-b-c)}O₂, LiCoO₂, LiNiO₂, LiMnO₂, LiMn₂O₄, Li₂MnO₃, LiCrO₂, Li₄Ti₅O₁₂, LiV₂O₅, LiTiS₂, LiMOS₂, LiCoₐNi_{b}O₂, LiMnₐNi_{b}O₂, and combinations thereof; wherein −0.2≤x≤0.2, 0≤a<1, 0≤b<1, 0≤c<1, and a+b+c≤1. In some embodiments, the shell also comprises a lithium transition metal oxide. In certain embodiments, the lithium transition metal oxide of the shell is selected from the above-mentioned group of lithium transitional metal oxides used for the core. In other embodiments, the shell comprises a transition metal oxide. In certain embodiments, the transition metal oxide of the shell is selected from the group consisting of Fe₂O₃, MnO₂, Al₂O₃, MgO, ZnO, TiO₂, La₂O₃, CeO₂, SnO₂, ZrO₂, RuO₂ and combinations thereof. In certain embodiments, the shell comprises a lithium transition metal oxide and a transition metal oxide.

In certain embodiments, the core and the shell each independently comprise two or more lithium transition metal oxides. In some embodiments, one of the core or shell comprises only one lithium transition metal oxide, while the other comprises two or more lithium transition metal oxides. The lithium transition metal oxide or oxides in the core and the shell may be the same, or they may be different or partially different. In some embodiments, the two or more lithium transition metal oxides are uniformly distributed over the core. In certain embodiments, the two or more lithium transition metal oxides are not uniformly distributed over the core.

In some embodiments, each of the metal oxides in the core and the shell is independently doped with a dopant selected from the group consisting of Co, Cr, V, Mo, Nb, Pd, F, Na, Fe, Ni, Mn, Al, Mg, Zn, Ti, La, Ce, Sn, Zr, Ru, Si, Ge and combinations thereof. In some embodiments, the cathode active material is not a core-shell composite.

In some embodiments, the electrode active material is a cathode active material for a sodium-ion battery. In some embodiments, the cathode active material for a sodium-ion battery is a Prussian blue-type sodium compound that satisfies the formula NaₓM_{y}A_{z}, wherein M is one or more metals and A is one or more anions that comprise one or more of O, P, N, C, H or a halogen. In certain embodiments, the cathode active material for a sodium-ion battery is the sodium analogue of the cathode active materials discussed above, with lithium replaced by sodium. In some embodiments, the cathode active material for a sodium-ion battery is selected from the group consisting of NaCoO₂, NaFeO₂, NaNiO₂, NaCrO₂, NaVO₂, NaTiO₂, NaFePO₄, Na₃V₂ (PO₄)₃, Na₃V₂ (PO₄)₂F₃, NMC-type mixed oxides, and combinations thereof. In some embodiments, the cathode active material for a sodium-ion battery is an organic material, such as disodium naphthalenediimide, doped quinone, pteridine derivatives, polyimides, polyamic acid, or combinations thereof.

In some embodiments, the cathode active material for a sodium-ion battery comprises or is a core-shell composite having a core and shell structure. In some embodiments, the cathode active material for a sodium-ion battery is doped with a dopant. The same dopants listed above for the cathode active material for a lithium-ion battery can be used to dope the cathode active material for a sodium-ion battery.

In some embodiments, the average diameter of the cathode active material particles is from about 0.1 μm to about 100 μm, from about 0.1 μm to about 50 μm, from about 0.5 μm to about 50 μm, from about 0.5 μm to about 30 μm, from about 0.5 μm to about 20 μm, from about 1 μm to about 20 μm, from about 2.5 μm to about 50 μm, from about 2.5 μm to about 20 μm, from about 5 μm to about 50 μm, from about 5 μm to about 20 μm, from about 7.5 μm to about 20 μm, from about 10 μm to about 50 μm, from about 10 μm to about 20 μm, from about 15 μm to about 50 μm, from about 15 μm to about 20 μm, from about 20 μm to about 50 μm, or from about 50 μm to about 100 μm.

In some embodiments, the average diameter of the cathode active material particles is less than 100 μm, less than 80 μm, less than 60 μm, less than 50 μm, less than 40 μm, less than 30 μm, less than 20 μm, less than 15 μm, less than 10 μm, less than 7.5 μm, less than 5 μm, less than 2.5 μm, less than 1 μm, less than 0.75 μm or less than 0.5 μm. In some embodiments, the average diameter of the cathode active material particles is more than 0.1 μm, more than 0.25 μm, more than 0.5 μm, more than 0.75 μm, more than 1 μm, more than 2.5 μm, more than 5 μm, more than 7.5 μm, more than 10 μm, more than 15 μm, more than 20 μm, more than 30 μm, more than 40 μm, or more than 50 μm.

In some embodiments, the electrode active material is an anode active material. In some embodiments, the anode active material is selected the group consisting of natural graphite particulate, synthetic graphite particulate, hard carbon, soft carbon, mesocarbon microbeads (MCMB), Sn particulate, SnO₂, SnO, Li₄Ti₅O₁₂ particulate, Si particulate, Si—C composite particulate and combinations thereof.

In certain embodiments, the anode active material is doped with a metallic element or a nonmetal element. In some embodiments, the metallic element is selected from the group consisting of Fe, Ni, Mn, Al, Mg, Zn, Ti, La, Ce, Sn, Zr, Ru and combinations thereof.

In some embodiments, the nonmetal element is B, Si, Ge, N, P, F, S, Cl, I, Se or combinations thereof.

In some embodiments, the anode active material comprises or is a core-shell composite having a core and shell structure, wherein the core and the shell each is independently selected from the group consisting of natural graphite particulate, synthetic graphite particulate, hard carbon, soft carbon, mesocarbon microbeads (MCMB), Sn particulate, SnO₂, SnO, Li₄Ti₅O₁₂ particulate, Si particulate, Si—C composite particulate, and combinations thereof.

In certain embodiments, the anode active material in the form of a core-shell composite comprises a core comprising a carbonaceous material and a shell coated on the carbonaceous material core. In some embodiments, the carbonaceous material is selected from the group consisting of soft carbon, hard carbon, natural graphite particulate, synthetic graphite particulate, mesocarbon microbeads, Kish graphite, pyrolytic carbon, mesophase pitches, mesophase pitch-based carbon fiber and combinations thereof. In certain embodiments, the shell is selected from the group consisting of natural graphite particulate, synthetic graphite particulate, hard carbon, soft carbon, mesocarbon microbeads (MCMB), Sn particulate, SnO₂, SnO, Li₄Ti₅O₁₂ particulate, Si particulate, Si—C composite particulate and combinations thereof.

In certain embodiments, the anode active material is not doped with a metallic element or a nonmetal element. In some embodiments, the anode active material is not doped with Fe, Ni, Mn, Al, Mg, Zn, Ti, La, Ce, Sn, Zr, Ru, B, Si, Ge, N, P, F, S, Cl, I, or Se.

In some embodiments, the electrode active material is an anode active material for a sodium-ion battery. Many embodiments of anode active materials used in lithium-ion batteries are also suitable for use as anode active material for a sodium-ion battery, although graphite is not preferable as the pores within the material are too small to hold sodium ions. Li₄Ti₅O₁₂ particulate is also not preferable as an anode active material for a sodium-ion battery as lithium is present, which would affect the reaction mechanism in a sodium-ion battery.

In some embodiments, the anode active material for a sodium-ion battery is selected from the group consisting of hard carbon, soft carbon, tin oxides such as SnO₂ and SnO, sodium titanates such as NaTi₂(PO₄)₃ and Na₂Ti₃O₇, SnS₂, NbS₂, SbOₓ, wherein 0<x≤ 2, Sn—P compounds and composites, sodium alloys and combinations thereof. In some embodiments, the anode active material for a sodium-ion battery is a Prussian blue-type sodium compound that satisfies the formula NaₓM_{y}A_{z}, wherein M is one or more metals and A is one or more anions that comprise one or more of O, P, N, C, H or a halogen.

In some embodiments, the anode active material for a sodium-ion battery comprises or is a core-shell composite having a core and shell structure. In some embodiments, the anode active material for a sodium-ion battery is doped with one or more elements selected form the group consisting of Sb, Sn, P, S, B, Al, Ga, In, Ge, Pb, As, Bi, Ti, Mo, Se, Te, Co and combinations thereof.

In some embodiments, the aqueous solvent in the conductive composition is sufficient to act as the solvent of the entire electrode slurry. In such embodiments, no additional solvent is added to form the aqueous solvent of the electrode slurry. In other embodiments, additional aqueous solvent is further added to the aqueous solvent of the conductive composition to form the aqueous solvent of the electrode slurry.

In I addition to promoting dispersion of CNTs in aqueous solvent, the copolymer in the conductive composition of the present invention also exhibits exceptionally strong binding capability. One way to assess the strength of the adhesive property of a polymeric material is via the adhesive strength between the polymeric material and a current collector.

In some embodiments, the adhesive strength between the copolymer and the current collector is from about 1 N/cm to about 10 N/cm, from about 1 N/cm to about 8 N/cm, from about 1 N/cm to about 5 N/cm, from about 1 N/cm to about 3 N/cm, from about 2 N/cm to about 10 N/cm, from about 2 N/cm to about 8 N/cm, from about 2 N/cm to about 5 N/cm, from about 3 N/cm to about 10 N/cm, from about 3 N/cm to about 8 N/cm, from about 3 N/cm to about 6 N/cm, from about 3 N/cm to about 5 N/cm, from about 4 N/cm to about 10 N/cm, from about 4 N/cm to about 8 N/cm, from about 4 N/cm to about 6 N/cm, from about 5 N/cm to about 10 N/cm, from about 5 N/cm to about 8 N/cm, from about 6 N/cm to about 10 N/cm, from about 6 N/cm to about 8 N/cm, or from about 7 N/cm to about 10 N/cm.

In some embodiments, the adhesive strength between the copolymer and the current collector is less than 10 N/cm, less than 9.5 N/cm, less than 9 N/cm, less than 8.5 N/cm, less than 8 N/cm, less than 7.5 N/cm, less than 7 N/cm, less than 6.5 N/cm, less than 6 N/cm, less than 5.5 N/cm, less than 5 N/cm, less than 4.5 N/cm, less than 4 N/cm, less than 3.5 N/cm, less than 3 N/cm, less than 2.5 N/cm, less than 2 N/cm, or less than 1.5 N/cm. In some embodiments, the adhesive strength between the copolymer and the current collector is more than 1 N/cm, more than 1.5 N/cm, more than 2 N/cm, more than 2.5 N/cm, more than 3 N/cm, more than 3.5 N/cm, more than 4 N/cm, more than 4.5 N/cm, more than 5 N/cm, more than 5.5 N/cm, more than 6 N/cm, more than 6.5 N/cm, more than 7 N/cm, more than 7.5 N/cm, more than 8 N/cm, more than 8.5 N/cm, more than 9 N/cm, or more than 9.5 N/cm.

Since the copolymer used to disperse the CNTs in the aqueous solvent of the conductive composition also has exceptional binding capacity, the copolymer can also act as a binder in the electrode layer of an electrode. The amount of copolymer present in the conductive composition is sufficient to bind the various electrode materials together and to the current collector. Accordingly, no additional binding agent needs to be present in the electrode slurry. Therefore, an additional advantage of the conductive composition of the present invention is that the usage of said conductive composition in an electrode slurry would significantly simplify the composition of the electrode slurry and thus an electrode produced therefrom, as well as the process of producing the electrode. However, additional binding agent may nonetheless be introduced to increase the binding capability of the electrode slurry onto the current collector. There are no particular limitations to the binding agent used, although the binding agent should have desirable properties as a binder, and in addition should be compatible with the various components in the conductive composition, such that the resultant electrode slurry is stable. Furthermore, it is preferable that the binding agent can be dispersed well in the electrode slurry to ensure an even, smooth coating. In some embodiments, the binding agent is aqueous in nature.

As mentioned above, the conductive composition of the present invention can be used in an electrode slurry to enhance the electrical conductivity of electrodes produced therefrom. In some embodiments, a conductive agent is also present in the electrode slurry to further improve the electrical conductivity of electrodes produced therefrom. In such embodiments, since CNTs are present in the electrode slurry, and are particularly effective at improving electrical conductivity of electrodes produced therefrom, less conductive agent can be used compared to electrode slurries known in the art. Any suitable material can act as the conductive agent. In some embodiments, the conductive agent is a carbonaceous material in the form of zero-dimensional carbon-based particles. CNTs have a shape synergistic effect when used in conjunction with zero-dimensional carbon-based particles, forming a three-dimensional conductive network which would to help further improve the electrical contact between various particles in electrodes. Some non-limiting examples of suitable carbonaceous materials include carbon, carbon black, graphite, expanded graphite, graphene, graphene nanoplatelets, carbon fibers, carbon nano-fibers, graphitized carbon flake, carbon tubes, activated carbon, Super P, 0-dimensional KS6,1-dimensional vapor grown carbon fibers (VGCF), mesoporous carbon and combinations thereof.

In some embodiments, the conductive agent comprises a conductive polymer selected from the group consisting of polypyrrole, polyaniline, polyacetylene, polyphenylene sulfide (PPS), polyphenylene vinylene (PPV), poly(3,4-ethylenedioxythiophene) (PEDOT), polythiophene, and combinations thereof. In some embodiments, the conductive polymer plays two roles simultaneously, not only as a conductive agent but also as a binder. In other embodiments, the conductive agent does not comprise a conductive polymer.

In other embodiments, the CNTs in the conductive composition is sufficient for the electrode slurry and any electrode produced therefrom to have excellent electrical conductivity. Accordingly, in such embodiments, no conductive agent is present in the electrode slurry.

When a conductive agent is present in the electrode slurry, the weight ratio of CNTs to conductive agent is critical in order to attain full utilization of the synergistic effect of CNTs and conductive agent in the electrode. In some embodiments, when a conductive agent is present in the electrode slurry, the weight ratio of the CNTs to the conductive agent is from about 1% to about 35%, from about 1% to about 30%, from about 1% to about 25%, from about 1% to about 20%, from about 1% to about 18%, from about 1% to about 16%, from about 1% to about 10%, from about 1% to about 8%, from about 1% to about 5%, from about 2% to about 35%, from about 2% to about 30%, from about 2% to about 25%, from about 2% to about 20%, from about 2% to about 15%, from about 3% to about 20%, from about 3% to about 15%, from about 5% to about 25%, from about 5% to about 20%, from about 5% to about 15%, from about 5% to about 10%, from about 7% to about 20%, from about 7% to about 15%, from about 10% to about 20%, or from about 10% to about 15%.

In some embodiments, when conductive agent is present in the electrode slurry, the weight ratio of the CNTs to the conductive agent is less than 35%, less than 30%, less than 25%, less than 20%, less than 18%, less than 16%, less than 14%, less than 12%, less than 10%, less than 9%, less than 8%, less than 7%, less than 6%, less than 5% or less than 4%. In some embodiments, when a conductive agent is present in the electrode slurry, the weight ratio of the CNTs to the conductive agent is more than 1%, more than 2%, more than 3%, more than 4%, more than 5%, more than 6%, more than 7%, more than 8%, more than 9%, more than 10%, more than 12%, more than 14%, more than 16%, more than 18%, more than 20%, more than 22%, more than 24%, or more than 26%.

In some embodiments, the electrode slurry may additionally comprise other additives for enhancing electrode properties. In some embodiments, the additives may include surfactants, dispersants and flexibility-enhancing additives, salts, ion conductive polymers, and inorganic solid-state electrolytes.

In some embodiments, the amount of the electrode active material in the electrode slurry is from about 30% to about 70%, from about 30% to about 65%, from about 30% to about 60%, from about 30% to about 55%, from about 30% to about 50%, from about 35% to about 70%, from about 35% to about 65%, from about 35% to about 60%, from about 35% to about 55%, from about 35% to about 50%, from about 40% to about 70%, from about 40% to about 65%, from about 40% to about 60%, from about 40% to about 55%, or from about 40% to about 50% by weight, based on the total weight of the electrode slurry.

In certain embodiments, the amount of the electrode active material in the electrode slurry is at least 30%, at least 35%, at least 40%, at least 45%, at least 50%, at least 55%, at least 60%, or at least 65% by weight, based on the total weight of the electrode slurry. In certain embodiments, the amount of the electrode active material in the electrode slurry is at most 70%, at most 65%, at most 60%, at most 55%, at most 50%, at most 45%, at most 40%, or at most 35% by weight, based on the total weight of the electrode slurry.

In certain embodiments, the amount of CNTs in the electrode slurry is from about 0.01% to about 3.0%, from about 0.01% to about 2.5%, from about 0.01% to about 2%, from about 0.01% to about 1.8%, from about 0.01% to about 1.6%, from about 0.01% to about 1.4%, from about 0.01% to about 1.2%, from about 0.01% to about 1.0%, from about 0.01% to about 0.8%, from about 0.01% to about 0.6%, from about 0.01% to about 0.4%, from about 0.05% to about 3.0%, from about 0.05% to about 2.5%, from about 0.05% to about 2%, from about 0.05% to about 1.8%, from about 0.05% to about 1.6%, from about 0.05% to about 1.4%, from about 0.05% to about 1.2%, from about 0.05% to about 1.0%, from about 0.05% to about 0.8%, from about 0.05% to about 0.6%, from about 0.05% to about 0.4%, from about 0.1% to about 3.0%, from about 0.1% to about 2.5%, from about 0.1% to about 2%, from about 0.1% to about 1.5%, from about 0.1% to about 1.2%, from about 0.1% to about 1.0%, from about 0.1% to about 0.8% or from about 0.1% to about 0.6% by weight, based on the total weight of the electrode slurry.

In some embodiments, the amount of CNTs in the electrode slurry is lower than 3.0%, lower than 2.8%, lower than 2.6%, lower than 2.4%, lower than 2.2%, lower than 2.0%, lower than 1.8%, lower than 1.6%, lower than 1.4%, lower than 1.2%, lower than 1.0%, lower than 0.8%, lower than 0.6%, or lower than 0.4% by weight, based on the total weight of the electrode slurry. In some embodiments, the amount of CNTs in the electrode slurry is higher than 0.01%, higher than 0.05%, higher than 0.1%, higher than 0.2%, higher than 0.4%, higher than 0.8%, higher than 1.2%, higher than 1.6%, higher than 2.0%, higher than 2.4%, or higher than 2.6% by weight, based on the total weight of the electrode slurry.

In some embodiments, the amount of conductive agent in the electrode slurry is from about 0.1% to about 5%, from about 0.1% to about 4.5%, from about 0.1% to about 4%, from about 0.1% to about 3.5%, from about 0.1% to about 3%, from about 0.1% to about 2%, from about 0.1% to about 1%, from about 0.1% to about 0.5%, from about 0.5% to about 5%, from about 0.5% to about 4.5%, from about 0.5% to about 4%, from about 0.5% to about 3.5%, from about 0.5% to about 3%, from about 0.5% to about 2.5%, from about 0.5% to about 2%, from about 1% to about 5%, from about 1% to about 4.5%, from about 1% to about 4%, from about 1% to about 3.5%, from about 1% to about 3%, from about 1.5% to about 5%, from about 1.5% to about 4.5%, from about 1.5% to about 4%, from about 1.5% to about 3.5%, from about 1.5% to about 3%, from about 2% to about 5%, from about 2% to about 4.5%, from about 2% to about 4%, from about 2% to about 3.5%, or from about 2% to about 3% by weight, based on the total weight of the electrode slurry. In other embodiments, the electrode slurry does not comprise any additional conductive agents other than CNTs.

In some embodiments, the amount of conductive agent in the electrode slurry is lower than 5%, lower than 4.5%, lower than 4%, lower than 3.5%, lower than 3%, lower than 2.5%, lower than 2%, lower than 1.5%, lower than 1%, or lower than 0.5% by weight, based on the total weight of the electrode slurry. In some embodiments, the amount of conductive agent in the electrode slurry is higher than 0%, higher than 0.5%, higher than 1%, higher than 1.5%, higher than 2%, higher than 2.5%, higher than 3%, higher than 3.5%, higher than 4%, or higher than 4.5% by weight, based on the total weight of the electrode slurry.

In some embodiments, the amount of binding agent in the electrode slurry is from about 0.1% to about 5%, from about 0.1% to about 4%, from about 0.1% to about 3%, from about 0.1% to about 2%, from about 0.5% to about 5%, from about 0.5% to about 4%, from about 0.5% to about 3%, from about 0.5% to about 2%, from about 1% to about 5%, from about 1% to about 4%, from about 1% to about 3%, or from about 1% to about 2% by weight, based on the total weight of the electrode slurry. In other embodiments, the electrode slurry does not comprise any binding agents.

In some embodiments, the amount of binding agent in the electrode slurry is lower than 5%, lower than 4%, lower than 3%, lower than 2%, lower than 1.8%, lower than 1.6%, lower than 1.4%, lower than 1.2%, lower than 1%, lower than 0.8%, lower than 0.6%, or lower than 0.4% by weight, based on the total weight of the electrode slurry. In some embodiments, the amount of binding agent in the electrode slurry is higher than 0%, higher than 0.25%, higher than 0.5%, higher than 0.75%, higher than 1%, higher than 1.2%, higher than 1.4%, higher than 1.6%, higher than 1.8%, higher than 2%, higher than 3%, or higher than 4% by weight, based on the total weight of the electrode slurry.

In some embodiments, the solid content of the electrode slurry is from about 35% to about 80%, from about 35% to about 75%, from about 35% to about 70%, from about 35% to about 65%, from about 35% to about 60%, from about 35% to about 55%, from about 40% to about 80%, from about 40% to about 75%, from about 40% to about 70%, from about 40% to about 65%, from about 40% to about 60%, from about 45% to about 80%, from about 45% to about 75%, from about 45% to about 70%, or from about 45% to about 65% by weight, based on the total weight of the electrode slurry.

In certain embodiments, the solid content of the electrode slurry is at least 35%, at least 40%, at least 45%, at least 50%, at least 55%, at least 60%, at least 65%, or at least 70% by weight, based on the total weight of the electrode slurry. In certain embodiments, the solid content of the electrode slurry is less than 75%, less than 70%, less than 65%, less than 60%, less than 55%, less than 50%, less than 45%, or less than 40% by weight, based on the total weight of the electrode slurry.

The electrode slurry of the present invention can have a higher solid content than conventional electrode slurries. This allows more electrode active material to be prepared for further processing at any one time, thus improving efficiency and maximizing productivity.

There are no particular limitations on the method used to produce an electrode slurry from the various electrode components, except that all electrode components should be mixed to form a homogeneous electrode slurry, for example through mixing in a homogenizer. In some embodiments, all the materials used to produce the electrode slurry are added into the homogenizer in a single batch. In other embodiments, each electrode component of the electrode slurry can be added to the homogenizer in one or more batches, and each batch may comprise more than one electrode component. Any homogenizer that can reduce or eliminate particle aggregation and/or promote homogeneous distribution of electrode components in the electrode slurry can be used herein. Homogeneous distribution plays an important role in fabricating batteries with good battery performance. In some embodiments, the homogenizer is a planetary stirring mixer, a stirring mixer, or a blender.

There are no particular limitations to the conditions used to form the electrode slurry, except such conditions should be sufficient to produce a homogenous slurry with good dispersion of the electrode components within the slurry. There are no particular limitations on the time taken or the temperature or stirring speed used to homogenize the electrode slurry, except that the time period, temperature and stirring speed should be sufficient to ensure homogeneous distribution of the various electrode components in the electrode slurry.

In some embodiments, after homogenization of an electrode slurry, the electrode slurry can be coated onto one side or both sides of a current collector to form an electrode layer. The current collector acts to collect electrons generated by electrochemical reactions of the cathode active material or to supply electrons required for the electrochemical reactions. In some embodiments, the current collector can be in the form of a foil, sheet or film. In some embodiments, the current collector is a metal. In some embodiments, the current collector is selected from the group consisting of stainless steel, titanium, nickel, aluminum, copper, platinum, gold, silver, chromium, zirconium, tungsten, molybdenum, silicon, tin, vanadium, zinc, cadmium, or alloys thereof. In some embodiments, the current collector further comprises an electrically-conductive resin.

In certain embodiments, the current collector has a two-layered structure comprising an outer layer and an inner layer, wherein the outer layer comprises a conductive material and the inner layer comprises an insulating material or another conductive material; for example, a polymeric insulating material coated with an aluminum layer or an aluminum mounted with a conductive resin layer. In some embodiments, the conductive material is selected from the group consisting of stainless steel, titanium, nickel, aluminum, copper, platinum, gold, silver, chromium, zirconium, tungsten, molybdenum, silicon, tin, vanadium, zinc, cadmium, or alloys thereof, electrically-conductive resin and combinations thereof.

In some embodiments, the current collector has a three-layered structure comprising an outer layer, a middle layer and an inner layer, wherein the outer and inner layers comprise a conductive material and the middle layer comprises an insulating material or another conductive material; for example, a plastic material coated with a metal layer on both sides. In certain embodiments, each of the outer layer, middle layer and inner layer is independently stainless steel, titanium, nickel, aluminum, copper, platinum, gold, silver, chromium, zirconium, tungsten, molybdenum, silicon, tin, vanadium, zinc, cadmium, or alloys thereof, electrically-conductive resin or combinations thereof.

In some embodiments, the insulating material is a polymeric material selected from the group consisting of polycarbonate, polyacrylate, polyacrylonitrile, polyester, polyamide, polystyrene, polyurethane, polyepoxy, poly(acrylonitrile butadiene styrene), polyimide, polyolefin, polyethylene, polypropylene, polyphenylene sulfide, poly(vinyl ester), polyvinyl chloride, polyether, polyphenylene oxide, cellulose polymer and combinations thereof. In certain embodiments, the current collector has more than three layers. In some embodiments, the current collector is coated with a protective coating. In certain embodiments, the protective coating comprises a carbon-containing material. In some embodiments, the current collector is not coated with a protective coating.

In some embodiments, a conductive layer can be coated on a current collector to improve its current conductivity. In certain embodiments, the conductive layer comprises a material selected from the group consisting of carbon, carbon black, graphite, expanded graphite, graphene, graphene nanoplatelets, carbon fibers, carbon nano-fibers, graphitized carbon flake, carbon tubes, carbon nanotubes, activated carbon, mesoporous carbon, and combinations thereof.

The thickness of the conductive layer will affect the volume occupied by the current collector within a battery and hence the thickness of the electrode, which in turn affects the capacity in the battery. In certain embodiments, the thickness of the conductive layer on the current collector is from about 0.5 μm to about 5.0 μm, from about 1.0 μm to about 4.0 μm, from about 1.0 μm to about 3.0 μm, from about 1.5 μm to about 2.0 μm, from about 1.0 μm to about 1.8 μm, from about 1.2 μm to about 1.8 μm or from about 1.0 μm to about 1.5 μm. In some embodiments, the thickness of the conductive layer on the current collector is less than 5.0 μm, less than 4.0 μm, less than 3.0 μm, less than 2.0 μm or less than 1.5 μm. In some embodiments, the thickness of the conductive layer on the current collector is more than 0.5 μm, more than 1.0 μm, more than 1.5 μm, more than 2.0 μm, more than 2.5 μm, more than 3.0 μm, or more than 3.5 μm.

The thickness of the current collector affects the volume it occupies within the battery, the thickness of the electrode, and hence the capacity in the battery. In some embodiments, the current collector has a thickness from about 5 μm to about 30 μm, from about 5 μm to about 20 μm, from about 5 μm to about 15 μm, from about 10 μm to about 30 μm, from about 10 μm to about 25 μm, or from about 10 μm to about 20 μm.

In some embodiments, the current collector has a thickness of less than 30 μm, less than 28 μm, less than 26 μm, less than 24 μm, less than 22 μm, less than 20 μm, less than 18 μm, less than 16 μm, less than 14 μm, less than 12 μm, less than 10 μm, less than 8 μm, or less than 6 μm. In some embodiments, the current collector has a thickness of more than 5 μm, more than 7 μm, more than 10 μm, more than 12 μm, more than 14 μm, more than 16 μm, more than 18 μm, more than 20 μm, more than 22 μm, more than 24 μm, more than 26 μm, or more than 28 μm.

There are no particular limitations to the equipment and the conditions used in coating the electrode slurry onto the current collector to form an electrode layer, except that a homogeneous, flat and smooth electrode layer film should be formed. In certain embodiments, the coating process is performed using a doctor blade coater, a slot-die coater, a transfer coater, a spray coater, a roll coater, a gravure coater, a dip coater, or a curtain coater. In some embodiments, the electrode slurry is applied directly onto a current collector. In other embodiments, the electrode slurry is first applied onto a release film to form a free-standing electrode layer. The free-standing electrode layer is then combined with a current collector and pressed to form an electrode layer.

In some embodiments, following the coating of the electrode slurry onto a current collector of the present invention, the coating is dried. Any equipment that can dry the coating in order to affix the electrode layer onto the current collector can be used herein.

There are no particular limitations to the conditions used for drying, except that the drying conditions should be sufficient to ensure that the electrode layer adheres strongly to the current collector. However, drying the electrode slurry at temperatures above 100° C. may result in undesirable deformation of the electrode, thus affecting the performance of the resultant electrode. In some embodiments, the resultant electrode is compressed mechanically following drying of the film in order to increase the density of the electrode.

In certain embodiments, the thickness of the electrode layer on the current collector is from about 10 μm to about 90 μm, from about 10 μm to about 80 μm, from about 10 μm to about 70 μm, from about 10 μm to about 60 μm, from about 10 μm to about 50 μm, from about 10 μm to about 40 μm, from about 10 μm to about 30 μm, from about 10 μm to about 20 μm, from about 25 μm to about 75 μm, from about 25 μm to about 50 μm, from about 30 μm to about 90 μm, from about 30 μm to about 80 μm, from about 35 μm to about 90 μm, from about 35 μm to about 85 μm, from about 35 μm to about 80 μm, or from about 35 μm to about 75 μm.

In some embodiments, the thickness of the electrode layer on the current collector is less than 25 μm, less than 30 μm, less than 35 μm, less than 40 μm, less than 45 μm, less than 50 μm, less than 55 μm, less than 60 μm, less than 65 μm, less than 70 μm, less than 75 μm, less than 80 μm, less than 85 μm, or less than 90 μm. In some embodiments, the thickness of the electrode layer on the current collector is higher than 10 μm, higher than 15 μm, higher than 20 μm, higher than 25 μm, higher than 30 μm, higher than 35 μm, higher than 40 μm, higher than 45 μm, higher than 50 μm, higher than 55 μm, higher than 60 μm, higher than 65 μm, higher than 70 μm, higher than 75 μm, or higher than 80 μm.

In some embodiments, the surface density of the electrode layer on the current collector is from about 1 mg/cm² to about 40 mg/cm², from about 1 mg/cm² to about 30 mg/cm2, from about 1 mg/cm² to about 20 mg/cm², from about 3 mg/cm² to about 40 mg/cm2, from about 3 mg/cm² to about 30 mg/cm², from about 3 mg/cm² to about 20 mg/cm2, from about 5 mg/cm² to about 40 mg/cm², from about 5 mg/cm² to about 30 mg/cm2, from about 5 mg/cm² to about 20 mg/cm², from about 8 mg/cm² to about 40 mg/cm2, from about 8 mg/cm² to about 30 mg/cm², from about 8 mg/cm² to about 20 mg/cm2, from about 10 mg/cm² to about 40 mg/cm², from about 10 mg/cm² to about 30 mg/cm2, from about 10 mg/cm² to about 20 mg/cm², from about 15 mg/cm² to about 40 mg/cm2, or from about 20 mg/cm² to about 40 mg/cm2.

In some embodiments, the surface density of the electrode layer on the current collector is higher than 1 mg/cm², higher than 5 mg/cm², higher than 10 mg/cm², higher than 15 mg/cm², higher than 20 mg/cm², higher than 25 mg/cm², higher than 30 mg/cm², or higher than 35 mg/cm². In some embodiments, the surface density of the electrode layer on the current collector is lower than 40 mg/cm², lower than 35 mg/cm², lower than 30 mg/cm², lower than 25 mg/cm², lower than 20 mg/cm², lower than 15 mg/cm², lower than 10 mg/cm², or lower than 5 mg/cm2.

In addition, the binders applied in the present invention (i.e. copolymer in the conductive composition, and optionally binding agent) allows the electrode layer to adhere to the current collector of an electrode. It is important for the electrode layer to have good peeling strength to the current collector as peeling strength greatly influences the mechanical stability of an electrode and the cyclability of a battery. Therefore, the electrode should have sufficient peeling strength to withstand the rigors of battery manufacture. In some embodiments, the peeling strength between the current collector and the electrode layer is in the range from about 1.0 N/cm to about 8.0 N/cm, from about 1.0 N/cm to about 6.0 N/cm, from about 1.0 N/cm to about 5.0 N/cm, from about 1.0 N/cm to about 4.0 N/cm, from about 1.0 N/cm to about 3.0 N/cm, from about 1.0 N/cm to about 2.5 N/cm, from about 1.0 N/cm to about 2.0 N/cm, from about 1.2 N/cm to about 3.0 N/cm, from about 1.2 N/cm to about 2.5 N/cm, from about 1.2 N/cm to about 2.0 N/cm, from about 1.5 N/cm to about 3.0 N/cm, from about 1.5 N/cm to about 2.5 N/cm, from about 1.5 N/cm to about 2.0 N/cm from about 1.8 N/cm to about 3.0 N/cm, from about 1.8 N/cm to about 2.5 N/cm, from about 2.0 N/cm to about 6.0 N/cm, from about 2.0 N/cm to about 5.0 N/cm, from about 2.0 N/cm to about 3.0 N/cm, from about 2.0 N/cm to about 2.5 N/cm, from about 2.2 N/cm to about 3.0 N/cm, from about 2.5 N/cm to about 3.0 N/cm, from about 3.0 N/cm to about 8.0 N/cm, from about 3.0 N/cm to about 6.0 N/cm, or from about 4.0 N/cm to about 6.0 N/cm.

In some embodiments, the peeling strength between the current collector and the electrode layer is 1.0 N/cm or more, 1.2 N/cm or more, 1.5 N/cm or more, 2.0 N/cm or more, 2.2 N/cm or more, 2.5 N/cm or more, 3.0 N/cm or more, 3.5 N/cm or more, 4.0 N/cm or more, 4.5 N/cm or more, 5.0 N/cm or more, 5.5 N/cm or more, 6.0 N/cm or more, 6.5 N/cm or more, 7.0 N/cm or more, or 7.5 N/cm or more. In some embodiments, the peeling strength between the current collector and the electrode layer is less than 8.0 N/cm, less than 7.5 N/cm, less than 7.0 N/cm, less than 6.5 N/cm, less than 6.0 N/cm, less than 5.5 N/cm, less than 5.0 N/cm, less than 4.5 N/cm, less than 4.0 N/cm, less than 3.5 N/cm, less than 3.0 N/cm, less than 2.8 N/cm, less than 2.5 N/cm, less than 2.2 N/cm, less than 2.0 N/cm, less than 1.8 N/cm, or less than 1.5 N/cm.

In some embodiments, after an electrode slurry comprising a conductive composition of the present invention is used to produce an electrode, said electrode can be assembled with a counter-electrode and an electrolyte to form a battery. When said electrode is a cathode, said counter-electrode is an anode; when said electrode is an anode, said counter-electrode is a cathode.

In some embodiments, the electrolyte is a liquid electrolyte. Such a liquid electrolyte comprises an electrolyte solvent and a salt. In some embodiments, said electrolyte solvent is water. In other embodiments, said electrolyte solvent is a liquid composed of one or more organic solvents. Some non-limiting examples of the organic solvent include dimethyl carbonate, diethyl carbonate, dipropyl carbonate, methylpropyl carbonate, ethylpropyl carbonate, ethyl methyl carbonate, ethylene carbonate, propylene carbonate, butylene carbonate, methyl acetate, methyl propanoate, ethyl acetate, n-propyl acetate, dimethylacetate, methyl propionate, ethyl propionate, dibutyl ether, tetraglyme, diglyme, dimethoxyethane, 2-methyltetrahydrofuran, tetrahydrofuran, methyl bromide, ethyl bromide, methyl formate, acetonitrile, dimethyl sulfoxide, dimethylformamide, N-methyl-2-pyrrolidone, and combinations thereof.

In some embodiments, the salt of the liquid electrolyte is a lithium salt. Some non-limiting examples of said lithium salt include LiPF₆, LiBO₂, LiBF₄, LiSbF₆, LiAsF₆, LiAlCl₄, LiClO₄, LiCI, LiI, LiNO₃, LiB(C₂O₄)₂, LiSO₃CF₃, LIN(SO₂F)₂, LIN(SO₂CF₃)₂, LIN(SO₂CF₂CF₃)₂, LiC₂H₃O₂, and combinations thereof.

In some embodiments, the salt of the liquid electrolyte is a sodium salt. In some embodiments, the sodium salt is the sodium analogue of the lithium salts discussed above, with the lithium replaced by sodium. Such sodium salts include NaPF₆, NaBF₄, NaN(SO₂CF₃)₂, NaN(SO₂F)₂, NaClO₄, and NaSO₃CF₃. In some embodiments, the sodium salt is one or more salts with the formula NaMFₓ, wherein each x=4 or 6, and wherein each M is selected from the group consisting of Al³⁺, B³⁺, Ga³⁺, In³⁺, Sc³⁺, Y³⁺, La³⁺, P⁵⁺, As⁵⁺.

In some embodiments, the electrolyte is a solid-state electrolyte. In some embodiments, said solid-state electrolyte is a polymer electrolyte. Such a polymer electrolyte comprises an ion-conductive polymer and a salt. In some embodiments, the salt of the polymer electrolyte is one or more lithium salts or one or more sodium salts discussed above.

In some embodiments, said solid-state electrolyte is an inorganic solid-state electrolyte. In certain embodiments, said inorganic solid-state electrolyte is for a solid-state lithium-ion battery. In some embodiments, the inorganic solid-state electrolyte for a solid-state lithium-ion battery is selected from the group consisting of LPS sulfides containing sulfur and phosphorus; lithium-phosphorus-iodine-oxygen sulfides; lithium-phosphorus-oxygen sulfides; lithium-zinc-germanium sulfides; lithium-germanium-sulfides; LLTO-based compounds; Perovskite compounds; NASICON compounds; lithium-aluminum-titanium-silicon phosphates; lithium-aluminum oxides; lithium-vanadium-germanium oxides; lithium-zinc-germanium oxides; lithium-lanthanum-zirconium oxides; lithium-lanthanum-zirconium-aluminum oxides; lithium-lanthanum-zirconium-tantalum oxides; Li₃N; lithium-aluminum chlorides; and combinations thereof.

In certain embodiments, said inorganic solid-state electrolyte is for a solid-state sodium-ion battery. In some embodiments, the inorganic solid-state electrolyte for a solid-state sodium-ion battery is the sodium analogue of the inorganic solid-state electrolytes suitable for use in a solid-state lithium-ion battery discussed above, with the lithium replaced by sodium. In some embodiments, inorganic solid-state electrolyte for a solid-state sodium-ion battery is a NASICON-type inorganic solid-state electrolyte, a NaPS sulfide containing sulfur and phosphorus, sodium polyaluminate, and combinations thereof.

In some embodiments, said solid-state electrolyte is a gel electrolyte. Such a gel electrolyte comprises a polymer electrolyte as discussed above, as well as an electrolyte solvent as discussed above.

As described above, through the action of the CNTs adhering to the copolymer and subsequent solvation of the CNT-copolymer complexes, the CNTs are well dispersed in the aqueous solvent of said conductive composition. Furthermore, the conductive composition remains stable even after a significant period of time. Therefore, through the conductive composition of the present invention, processing and handling of CNTs can be made much easier, while excellent CNT performance is retained. Accordingly, the conductive composition of the present invention could then be used in any existing or potential applications of CNTs, such as in batteries. More specifically, the conductive composition is highly suitable for use in an aqueous solvent-based electrode slurry that comprises an electrode active material in addition to the conductive composition. The electrode slurry may further comprise a conductive agent, additional aqueous solvent, and/or a binding agent, although binding agent in particular may not be necessary since the copolymer in the conductive composition could also act as binder in the electrode slurry. Accordingly, development of water-based slurries with a simple composition and comprising CNTs without lowering battery performance, such as cyclability and capacity, is achieved by the present invention. Batteries comprising electrodes prepared using the present invention show high cycle stability.

The following examples are presented to exemplify embodiments of the invention but are not intended to limit the invention to the specific embodiments set forth. Unless indicated to the contrary, all parts and percentages are by weight. All numerical values are approximate. When numerical ranges are given, it should be understood that embodiments outside the stated ranges may still fall within the scope of the invention. Specific details described in each example should not be construed as necessary features of the invention.

While the invention has been described with respect to a limited number of embodiments, the specific features of one embodiment should not be attributed to other embodiments of the invention. In some embodiments, the methods may include numerous steps not mentioned herein. In other embodiments, the methods do not include, or are substantially free of, any steps not enumerated herein. Variations and modifications from the described embodiments exist. The appended claims intend to cover all those modifications and variations as falling within the scope of the invention.

### EXAMPLES

The pH values of the conductive compositions were measured using an electrode-type pH meter (ION 2700, Eutech Instruments).

The dynamic viscosities of the conductive compositions were measured with a HAAKE™ Viscotester™ iQ (Thermo Fisher Scientific), at 22° C.

The resistances of the conductive compositions were measured using an ohm-meter (UT204A, Uni Trend Technology China Co. Ltd., China). The conductive composition was coated onto a glass slide to a thickness of 0.5 mm, after which the conductive composition was dried using an electrically heated oven at 70° C. The drying time was about 30 mins, and the resultant conductive layer had a thickness of around 0.02 mm. The two probes of the ohm-meter was placed on the conductive layer at two points spaced 10 mm apart. Measurements were repeated three times to find the average value.

The stability of the conductive compositions was measured by observation. A 50 cm3 sample of a conductive composition was transferred into a beaker and the beaker was sealed. The sealed beaker was then left at room temperature for one week. Said conductive composition is considered stable if no sedimentation was observed after one week, indicating no aggregation of CNTs occurred, and that the conductive composition remained homogeneous.

The adhesive strengths of the dried copolymer dispersions were measured by a tensile testing machine (DZ-106A, obtained from Dongguan Zonhow Test Equipment Co. Ltd., China). This test measures the average force required to peel a copolymer layer from the current collector at 180° angle in Newtons. The mean roughness depth (Rz) of the current collector is 2 μm. The copolymer was coated on the current collector and dried to obtain a layer of thickness 10 μm to 12 μm. The coated current collector was then placed in an environment of constant temperature of 25° C. and humidity of 50% for 30 minutes. A strip of adhesion tape (3M; US; model no. 810) with a width of 18 mm and a length of 20 mm was attached onto the surface of the binder layer. The binder strip was clipped onto the testing machine and the tape was folded back on itself at 180 degrees, and placed in a moveable jaw and pulled at room temperature and a peel rate of 100 mm per minute. The maximum stripping force measured was taken as the adhesive strength. Measurements were repeated three times to find the average value.

### Example 1

### A) Preparation of Copolymer

22.34 g of sodium hydroxide (NaOH) was added into a round-bottom flask containing 1140 g of distilled water. The mixture was stirred at 80 rpm for 30 mins to obtain a first suspension.

50.29 g of acrylic acid was added into the first suspension. The mixture was further stirred at 80 rpm for 30 mins to obtain a second suspension.

21.57 g of acrylamide was dissolved in 30 g of DI water to form an acrylamide solution. Thereafter, 51.57 g of acrylamide solution was added into the second suspension. The mixture was further heated to 55° C. and stirred at 80 rpm for 45 mins to obtain a third suspension.

107.88 g of acrylonitrile was added into the third suspension. The mixture was further stirred at 80 rpm for 10 mins to obtain a fourth suspension.

Further, 0.045 g of water-soluble free radical initiator (ammonium persulfate, APS; obtained from Aladdin Industries Corporation, China) was dissolved in 9 g of DI water and 0.0225 g of reducing agent (sodium bisulfite; obtained from Tianjin Damao Chemical Reagent Factory, China) was dissolved in 4.5 g of DI water. 9.045 g of APS solution and 4.5225 g of sodium bisulfite solution were added into the fourth suspension. The mixture was stirred at 200 rpm for 24 h at 55° C. to obtain a fifth suspension.

After the complete reaction, the temperature of the fifth suspension was lowered to 25° C. 11.16 g of NaOH was dissolved in 1200 g of DI water. Thereafter, 1211.16 g of sodium hydroxide solution was added dropwise into the fifth suspension. The fifth suspension was filtered using 200 μm nylon mesh. The copolymer was successfully produced, and is in the form of an aqueous dispersion. The weight-average molecular weight of the copolymer was about 153,000 g/mol, and the copolymer dispersion had a solid content of 7.69 wt. %. The adhesive strength between the copolymer and the current collector was 3.40 N/cm.

### B) Preparation of Conductive Composition

1755.5 g of the copolymer dispersion of Example 1 (7.69 wt. % solid content) was added to 1231.0 g of DI water, while stirring with an overhead stirrer (R20, IKA). After the addition, the mixture was further stirred for about 10 minutes at 25° C. at a speed of 500 rpm to form a first composition.

13.5 g of CNTs (obtained from Jiangsu Cnano Technology Co. Ltd., China) in the form of dry powder was added to the first composition. The CNTs had an average diameter of 7-11 nm, an average length of 50-250 μm, and a BET specific surface area of 250-350 m²/g. After the addition, the mixture was further stirred for about 15 minutes at 25° C. at a speed of 500 rpm to form a second composition.

Following the formation of the second composition, the second composition was transferred to a sand mill (CNT-TIL, KANGBO Machinery Co. Ltd., China). The second composition was further milled for about 2 hours at 25° C. at a speed of 2000 rpm to form the conductive composition. The pH of the conductive composition was around 7.3.

Three more iterations of Example 1 were prepared with minor changes to the specifications of the CNTs.

In the first iteration, the CNTs had an average diameter of 7-11 nm, an average length of 5-20 μm, and a BET specific surface area of 200-300 m²/g.

In the second iteration, the CNTs had an average diameter of 2.4 nm, an average length of around 500 μm, and a BET specific surface area of around 450 m²/g.

In the third iteration, the CNTs had an average diameter of 10-25 nm, an average length of around 10 μm, and a BET specific surface area of 110-250 m²/g.

### C) Preparation of Positive Electrode

A first mixture was prepared by dispersing 7.8 g of conductive agent (SuperP; obtained from Timcal Ltd, Bodio, Switzerland) into 200 g of the conductive composition of Example 1 while stirring with an overhead stirrer (R20, IKA). After the addition, the first mixture was further stirred for about 30 mins at 25° C. at a speed of 1,200 rpm.

Thereafter, a second mixture was prepared by adding 276 g of NMC811 (obtained from Shandong Tianjiao New Energy Co., Ltd, China) to the first mixture at 25° C. while stirring with an overhead stirrer. Then, the second mixture was degassed under a pressure of about 10 kPa for 1 hour. The second mixture was further stirred for about 60 mins at 25° C. at a speed of 1,200 rpm to form a homogenized cathode slurry.

The homogenized cathode slurry was coated onto both sides of the surface of the current collector prepared above using a doctor blade coater with a gap width of 120 μm. The coated slurry of 80 μm on the current collector was dried to form a cathode layer using an electrically heated oven at 85° C. The drying time was about 20 mins. The electrode was then pressed to decrease the thickness of the cathode layer to 50 μm. The surface density of the cathode layer on the current collector is 16.00 mg/cm2.

### D) Assembly of Coin Cell

The electrochemical performance of the cathode prepared above was tested in CR2032 coin-type Li cells assembled in an argon-filled glove box. The cathode was cut into disc-form shapes for coin-type cell assembly. A lithium metal foil having a thickness of 500 μm was used as a counter-electrode. The cathode and counter-electrode were kept apart by a separator. The separator was a ceramic coated microporous membrane made of nonwoven fabric (MPM, Japan), which had a thickness of about 25 μm. The electrode assembly was then dried in a box-type resistance oven under vacuum (DZF-6020, obtained from Shenzhen Kejing Star Technology Co. Ltd., China) at 105° C. for about 16 hours.

An electrolyte was then injected into the case holding the packed electrodes under a high-purity argon atmosphere with a moisture and oxygen content of less than 3 ppm respectively. The electrolyte was a solution of LiPF₆ (1 M) in a mixture of ethylene carbonate (EC), ethyl methyl carbonate (EMC) and dimethyl carbonate (DMC) at a volume ratio of 1:1:1. After electrolyte filling, the coin cell was mechanically pressed using a punch tooling with a standard circular shape.

### E) Performance Measurements

The dynamic viscosity and resistance of the conductive composition were measure respectively. The stability performance of the conductive composition was then evaluated. The results of the performance measurements of the conductive composition of Example 1 are shown in Table 1 below, wherein a conductive composition that is considered stable would be signified by “Y”, while a conductive composition that is not considered stable would be signified by “N”.

The viscosity, resistance and stability of conductive compositions of the various iterations of CNT specifications were also measured, and it was found that these conductive compositions had performances and properties similar to that of the conductive composition of Example 1.

The coin cells were analyzed in a constant current mode using a multi-channel battery tester (BTS-4008-5V10 mA, obtained from Neware Electronics Co. Ltd, China). After 1 cycle at C/20 was completed, they were charged and discharged at a rate of C/2. The charging/discharging cycling tests of the cells were performed between 3.0 and 4.3 V at a current density of C/2 at 25° C. to obtain the discharge capacity. The electrochemical performance of the coin cell of Example 1 was measured and is shown in Table 1 below.

The performances of coin cells comprising conductive compositions of the various iterations of CNT specifications were also measured, and it was found that these conductive compositions had performances similar to that of the conductive composition of Example 1.

### Preparation of Conductive Composition of Example 2

### A) Preparation of Copolymer

A copolymer dispersion was prepared with the method described in Example 1, except that 25.98 g of sodium hydroxide was added in the preparation of the first suspension, 56.85 g of acrylic acid was added in the preparation of the second suspension, 38.82 g of acrylamide was added in the preparation of the third suspension, and 90.17 g of acrylonitrile was added in the preparation of the fourth suspension. The weight-average molecular weight of the copolymer was around 158,000 g/mol, and the copolymer dispersion had a solid content of 8.07 wt. %.

### B) Preparation of Conductive Composition

A conductive composition was prepared with the method described in Example 1, except that 1672.9 g of the copolymer dispersion of Example 2 (8.07 wt. % solid content) was added to 1313.6 g of DI water in the preparation of the first composition. The pH of the conductive composition was around 7.6.

### Preparation of Conductive Composition of Example 3

### A) Preparation of Copolymer

A copolymer dispersion was prepared with the method described in Example 1, except that 36.91 g of sodium hydroxide was added in the preparation of the first suspension, 76.53 g of acrylic acid was added in the preparation of the second suspension, 43.14 g of acrylamide was added in the preparation of the third suspension, and 72.46 g of acrylonitrile was added in the preparation of the fourth suspension. The weight-average molecular weight of the copolymer was around 161,000 g/mol, and the copolymer dispersion had a solid content of about 8.23 wt. %.

### B) Preparation of Conductive Composition

A conductive composition was prepared with the method described in Example 1, except that 1640.3 g of the copolymer dispersion of Example 3 (8.23 wt. % solid content) was added to 1346.2 g of DI water in the preparation of the first composition. The pH of the conductive composition was around 7.4.

### Preparation of Conductive Composition of Example 4

### A) Preparation of Copolymer

A copolymer dispersion was prepared with the method described in Example 1, except that 55.11 g of sodium hydroxide was added in the preparation of the first suspension, 109.33 g of acrylic acid was added in the preparation of the second suspension, 21.57 g of acrylamide was added in the preparation of the third suspension, and 64.40 g of acrylonitrile was added in the preparation of the fourth suspension. The weight-average molecular weight of the copolymer was around 167,000 g/mol, and the copolymer dispersion had a solid content of about 8.90 wt. %.

### B) Preparation of Conductive Composition

A conductive composition was prepared with the method described in Example 1, except that 1516.9 g of the copolymer dispersion of Example 4 (8.90 wt. % solid content) was added to 1469.7 g of DI water in the preparation of the first composition. The pH of the conductive composition was around 7.1.

### Preparation of Conductive Composition of Example 5

A conductive composition was prepared with the method described in Example 1, except that 2496.8 g of the copolymer dispersion of Example 1 (7.69 wt. % solid content) was added to 484.1 g of DI water in the preparation of the first composition, and 19.2 g of CNTs were added in the preparation of the second composition. The pH of the conductive composition was around 7.3.

### Preparation of Conductive Composition of Example 6

A conductive composition was prepared with the method described in Example 1, except that 1950.6 g of the copolymer dispersion of Example 1 (7.69 wt. % solid content) was added to 1041.9 g of DI water in the preparation of the first composition, and 7.5 g of CNTs were added in the preparation of the second composition. The pH of the conductive composition was around 7.5.

### Preparation of Conductive Composition of Example 7

A conductive composition was prepared with the method described in Example 1, except that 2535.8 g of the copolymer dispersion of Example 1 (7.69 wt. % solid content) was added to 425.2 g of DI water in the preparation of the first composition, and 39 g of CNTs were added in the preparation of the second composition. The pH of the conductive composition was around 7.9.

### Preparation of Conductive Composition of Example 8

A conductive composition was prepared with the method described in Example 1, except that 0.01M sodium hydroxide was additionally added to the second composition to increase the pH of the conductive composition to around 8.5.

### Preparation of Conductive Composition of Example 9

A conductive composition was prepared with the method described in Example 1, except that 0.01M sodium hydroxide was additionally added to the second composition to increase the pH of the conductive composition to around 9.5.

### Preparation of Positive Electrodes of Examples 2-9

Positive electrodes were prepared with the method described in Example 1, except the respective conductive compositions were used in the preparation of the cathode slurry instead of the conductive composition of Example 1.

### Preparation of Coin Cells of Examples 2-9

Coin cells were prepared with the method described in Example 1.

### Performance Measurements of Examples 2-9

Performance measurements were taken by the same method described in Example 1. The results of the performance measurements of the conductive compositions of Examples 2-9 are shown in Table 1 below.

### Preparation of Composition of Comparative Example 1

A composition was prepared with the method described in Example 1, except that 1244.5 g of DI water was added in the preparation of the first composition, and no CNTs were added in the preparation of the second composition. The pH of the composition was around 7.2.

### Preparation of Composition of Comparative Example 2

A composition was prepared with the method described in Example 4, except that 1483.2 g of DI water was added in the preparation of the first composition, and no CNTs were added in the preparation of the second composition. The pH of the composition was around 7.3.

### Preparation of Conductive Composition of Comparative Example 3

A conductive composition was prepared with the method described in Example 1, except that 1240.6 g of DI water was used in the preparation of the first composition, and 3.9 g of CNTs were added in the preparation of the second composition. The pH of the conductive composition was around 7.7.

### Preparation of Conductive Composition of Comparative Example 4

A conductive composition was prepared with the method described in Example 1, except that 78.0 g of the copolymer dispersion of Example 1 (7.69 wt. % solid content) was added to 2832.0 g of DI water in the preparation of the first composition, and 90 g of CNTs were added in the preparation of the second composition. The pH of the conductive composition was around 7.9.

### Preparation of Conductive Composition of Comparative Example 5

A conductive composition was prepared with the method described in Example 1, except that 385.7 g of 35% sodium polyacrylate solution (Obtained from Polysciences Inc., USA) was added to 2600.8 g of DI water in the preparation of the first composition. The pH of the conductive composition was about 7.8.

### Preparation of Conductive Composition of Comparative Example 6

A conductive composition was prepared with the method described in Example 1, except that 135 g of polyacrylamide (Obtained from Sigma-Aldrich, Germany) was added to 2851.5 g of DI water in the preparation of the first composition. The pH of the conductive composition was about 7.9.

### Preparation of Conductive Composition of Comparative Example 7 A) Preparation of Copolymer

A copolymer dispersion was prepared with the method described in Example 1, except that 30.84 g of sodium hydroxide was added in the preparation of the first suspension, 65.60 g of acrylic acid was added in the preparation of the second suspension, acrylamide was not added in the preparation of the third suspension, and 112.71 g of acrylonitrile was added in the preparation of the fourth suspension. The weight-average molecular weight of the copolymer was around 147,000 g/mol, and the copolymer dispersion had a solid content of about 7.87 wt. %.

### B) Preparation of Conductive Composition

A conductive composition was prepared with the method described in Example 1, except that 1715.4 g of the copolymer dispersion of Comparative Example 7 (7.87 wt. % solid content) was added to 1271.1 g of DI water in the preparation of the first composition. The pH of the conductive composition was around 7.3.

### Preparation of Conductive Composition of Comparative Example 8

### A) Preparation of Copolymer

A copolymer dispersion was prepared with the method described in Example 1, except that 85.45 g of sodium hydroxide was added in the preparation of the first suspension, 164.00 g of acrylic acid was added in the preparation of the second suspension, 53.92 g of acrylamide was added in the preparation of the third suspension, and acrylonitrile was not added in the preparation of the fourth suspension. The weight-average molecular weight of the copolymer was around 173,000 g/mol, and the copolymer dispersion had a solid content of about 10.65 wt. %.

### B) Preparation of Conductive Composition

A conductive composition was prepared with the method described in Example 1, except that 1267.6 g of the copolymer dispersion of Comparative Example 8 (10.65 wt. % solid content) was added to 1718.9 g of DI water in the preparation of the first composition. The pH of the conductive composition was around 7.6.

### Preparation of Conductive Composition of Comparative Example 9

A conductive composition was prepared with the method described in Example 1, except that no sodium hydroxide was added to the fifth suspension in the preparation of the copolymer. The pH of the conductive composition was around 5.4.

### Preparation of Conductive Composition of Comparative Example 10

A conductive composition was prepared with the method described in Example 4, except that no sodium hydroxide was added to the fifth suspension in the preparation of the copolymer. The pH of the conductive composition was around 5.1.

### Preparation of Positive Electrodes of Comparative Examples 1-3

Positive electrodes were prepared with the method described in Example 1, except the respective compositions of Comparative Examples 1-3 were used in the preparation of the cathode slurry.

### Preparation of Coin Cells of Comparative Examples 1-3

Coin cells were prepared with the method described in Example 1.

### Performance Measurements of Comparative Examples 1-3

Performance measurements were taken by the same method described in Example 1. The results of the performance measurements of the conductive compositions of Comparative Examples 1-3 are shown in Table 1 below.

### Performance Measurements of Comparative Examples 4, 9-10

It was observed that a well dispersed conductive composition could not be produced even initially after completion of milling. As such, no further performance measurements were conducted.

### Performance Measurements of Comparative Examples 5-8

It was observed that a stable conductive composition could not be produced. As such, no further performance measurements were conducted.

TABLE 1

| | | | | | | | | | | Battery performance | |
|---|---|---|---|---|---|---|---|---|---|---|---|
| | Proportion of | | | | | | | | | 0.5 C Initial | Capacity |
| | structural units | | | Conductive composition | | | | | | discharging | retention |
| | (mol %) | | | Copolymer | CNTs | | Viscosity | Resistance | Stability | capacity | after 50 |
| | (a) | (b) | (c) | (wt. %) | (wt. %) | pH | (mPa · s) | (kΩ) | (Y/N) | (mAh/g) | cycles (%) |
| Example 1 | 67 | 23 | 10 | 4.5 | 0.45 | 7.3 | 700 | 61 | Y | 190.4 | 95.6 |
| Example 2 | 56 | 26 | 18 | 4.5 | 0.45 | 7.6 | 900 | 69 | Y | 189.0 | 96.2 |
| Example 3 | 45 | 35 | 20 | 4.5 | 0.45 | 7.4 | 1300 | 68 | Y | 192.6 | 95.5 |
| Example 4 | 40 | 50 | 10 | 4.5 | 0.45 | 7.1 | 1500 | 64 | Y | 188.0 | 95.3 |
| Example 5 | 67 | 23 | 10 | 6.4 | 0.64 | 7.3 | 900 | 57 | Y | 194.5 | 96.9 |
| Example 6 | 67 | 23 | 10 | 5.0 | 0.25 | 7.5 | 880 | 94 | Y | 187.2 | 97.1 |
| Example 7 | 67 | 23 | 10 | 6.5 | 1.3 | 7.9 | 950 | 9 | Y | 188.9 | 95.7 |
| Example 8 | 67 | 23 | 10 | 4.5 | 0.45 | 8.5 | 780 | 62 | Y | 188.8 | 94.8 |
| Example 9 | 67 | 23 | 10 | 4.5 | 0.45 | 9.5 | 810 | 64 | Y | 187.6 | 95.7 |
| Comparative | 67 | 23 | 10 | 4.5 | — | 7.2 | 300 | >1 × 10⁷ | Y | 181.1 | 85.9 |
| Example 1 | | | | | | | | | | | |
| Comparative | 40 | 50 | 10 | 4.5 | — | 7.3 | 350 | >1 × 10⁷ | Y | 184.5 | 82.2 |
| Example 2 | | | | | | | | | | | |
| Comparative | 67 | 23 | 10 | 4.5 | 0.13 | 7.7 | 450 | 5000 | Y | 184.9 | 83.6 |
| Example 3 | | | | | | | | | | | |

1. A conductive composition, comprising a copolymer, carbon nanotubes, and an aqueous solvent, wherein the copolymer comprises a structural unit (a), and wherein structural unit (a) comprises one or more monomeric unit(s) containing a cyano group.

2. The conductive composition of claim 1, wherein the proportion of structural unit (a) in the copolymer is from about 20% to about 70% by mole, based on the total number of moles of monomeric units in the copolymer.

3. The conductive composition of claim 1, wherein the pH of the conductive composition is from about 7 to about 12.

4. The conductive composition of claim 1, wherein the copolymer further comprises a structural unit (b), wherein structural unit (b) comprises one or more monomeric unit(s) containing a carboxylate salt group.

5. The conductive composition of claim 4, wherein the proportion of structural unit (b) in the copolymer is from about 10% to about 50% by mole, based on the total number of moles of monomeric units in the copolymer.

6. The conductive composition of claim 1, wherein the copolymer further comprises a structural unit (c), wherein structural unit (c) comprises one or more monomeric unit(s) containing an amide group.

7. The conductive composition of claim 6, wherein the proportion of structural unit (c) in the copolymer is from about 6% to about 25% by mole, based on the total number of moles of monomeric units in the copolymer.

8. The conductive composition of claim 1, wherein the proportion of copolymer in the conductive composition is from about 4% to about 10% by weight, based on the total weight of the conductive composition.

9. The conductive composition of claim 1, wherein the carbon nanotubes are selected from the group consisting of multi-walled carbon nanotubes, few-walled carbon nanotubes, double-walled carbon nanotubes, single-walled carbon nanotubes, and combinations thereof.

10. The conductive composition of claim 1, wherein the average diameter of the carbon nanotubes is from about 0.1 nm to about 100 nm; and wherein the aspect ratio of the carbon nanotubes is from about 10 to about 5×10⁶; and wherein the BET specific surface area of the carbon nanotubes is from about 100 m²/g to about 1,500 m²/g.

11. The conductive composition of claim 1, wherein the proportion of carbon nanotubes in the conductive composition is from about 0.2% to about 3.5% by weight, based on the total weight of the conductive composition.

12. The conductive composition of claim 1, wherein the ratio of the weight of the carbon nanotubes to the weight of the copolymer is from about 1:20 to about 1:3.

13. The conductive composition of claim 1, wherein the proportion of the sum of copolymer and carbon material in the conductive composition is from about 4% to about 13% by weight, based on the total weight of the conductive composition.

14. The conductive composition of claim 1, wherein the aqueous solvent is water.

15. The conductive composition of claim 1, wherein the viscosity of the conductive composition at 20° C. is from about 500 mPa·s to about 2,000 mPa·s.

16. An electrode slurry, comprising the conductive composition of claim 1 and an electrode active material.

17. The electrode slurry of claim 16, wherein the electrode active material is a cathode active material selected from the group consisting of LiCoO₂, LiNiO₂, LiNi₁₋ₓMₓO₂, LiNiₓMn_{y}O₂, LiCoₓNi_{y}O₂, Li_{1+z}NiₓMn_{y}CO_{1-x-y}O₂, LiNiₓCo_{y}Al₂O₂, LiV₂O₅, LiTiS₂, LiMOS₂, LiMnO₂, LiCrO₂, LiMn₂O₄, Li₂MnO₃, LiFeO₂, LiFePO₄, and combinations thereof; wherein each x is independently from 0.1 to 0.9; each y is independently from 0 to 0.9; each z is independently from 0 to 0.4; and wherein M is selected from the group consisting of Co, Mn, Al, Fe, Ti, Ga, Mg, and combinations thereof.

18. The electrode slurry of claim 16, wherein the electrode active material is a cathode active material selected from the group consisting of NaCoO₂, NaFeO₂, NaNiO₂, NaCrO₂, NaVO₂, NaTiO₂, NaFePO₄, Na₃V₂ (PO₄)₃, Na₃V₂ (PO₄)₂F₃, NMC-type mixed oxides, Prussian blue-type sodium compounds, and combinations thereof.

19. The electrode slurry of claim 16, wherein the electrode active material is an anode active material selected the group consisting of natural graphite particulate, synthetic graphite particulate, hard carbon, soft carbon, mesocarbon microbeads (MCMB), Sn particulate, SnO₂, SnO, Li₄Ti₅O₁₂ particulate, Si particulate, Si—C composite particulate, and combinations thereof.
